(19) United States
(12) Patent Application Publication
(10) Pub. No.: US 2023/0296532 A1
(43) Pub. Date: Sep. 21, 2023

(54) SYSTEMS AND METHODS FOR BLOW-FILL-SEAL (BFS) PRODUCT INSPECTION

(71) Applicant: Koska Family Limited, East Sussex (GB)

(72) Inventors: Joe Chan, Portage, MI (US); Barry Hendy, Victoria (AU); Philip Leslie, Victoria (AU)

(21) Appl. No.: 18/198,979

(22) Filed: May 18, 2023

Related U.S. Application Data
(63) Continuation of application No. PCT/US2021/060813, filed on Nov. 24, 2021.
(60) Provisional application No. 63/118,001, filed on Nov. 24, 2020.

(51) Int. Cl. G01N 21/90

(52) U.S. Cl. CPC G01N 21/90

(57) ABSTRACT

An inspection system is provided for a pre-filled blow-fill-seal (BFS) product. The BFS product comprises a neck that extends along a longitudinal direction and has a coupling portion that protrudes laterally outward with respect to adjacent portions of the neck. The inspection system comprises a controller and a first inspection station, which includes illumination and detection assemblies. Interrogating light from one or more light sources of the illumination assembly is directed at a perimeter of the coupling portion of the neck. The detection assembly has an input optical axis that extends along the longitudinal direction and comprises an imaging device to detect light emitted from the neck. The controller is configured to determine compliance of the BFS product with respect to predetermined criteria based at least in part on the light detected by the imaging device.

### CROSS-REFERENCE TO RELATED APPLICATIONS

This application is a Continuation Application of PCT Application No. PCT/US21/060813, filed on Nov. 24, 2021 in the name of Chan et al. and titled SYSTEMS AND METHODS FOR BLOW-FILL-SEAL (BFS) PRODUCT INSPECTION, which PCT Application claims benefit of and priority under 35 U.S.C. § 119(e) to, and is a Non-provisional of U.S. Provisional Patent Application No. 63/118,001, filed on Nov. 24, 2020, and titled “SYSTEMS AND METHODS FOR BLOW-FILL-SEAL (BFS) PRODUCT INSPECTION.” Each of these Applications is hereby incorporated by reference herein in its entirety and for all purposes.

### BACKGROUND

Every year, millions of people become infected and die from a variety of diseases, some of which are vaccine-preventable. Although vaccination has led to a dramatic decline in the number of cases of several infectious diseases, some of these diseases remain quite common. In many instances, large populations of the world, particularly in developing countries, suffer from the spread of vaccine-preventable diseases due to ineffective immunization programs, either because of poor implementation, lack of affordable vaccines, or inadequate devices for administering vaccines, or combinations thereof.

Some implementations of immunization programs include administration of vaccines via a reusable syringe. However, in many situations, particularly in developing countries, the administration of vaccines occur outside of a hospital and may be provided by a non-professional, such that injections are given to patients without carefully controlling access to syringes. The use of reusable syringes under those circumstances increases the risk of infection and spread of blood-borne diseases, particularly when syringes, which have been previously used and are no longer sterile, are used to administer subsequent injections. For example, the World Health Organization (WHO) estimates that blood-borne diseases, such as Hepatitis and human immunodeficiency virus (HIV), are being transmitted due to reuse of such syringes, resulting in the death of more than one million people each year.

Previous attempts at providing single-use or disposable injection devices to remedy such problems in the industry have achieved measurable success but have failed to adequately remedy the existing problems. Pre-filled, single-use injection devices manufactured via injection molding or Form-Fill-Seal (FFS) processes, such as the Uniject™ device available from the Becton, Dickinson and Company of Franklin Lakes, N.J., for example, while offering precise manufacturing tolerances in the range of two thousandths of an inch (0.002-in; 50.8 μm) to four thousandths of an inch (0.004-in; 101.6 μm)—for hole diameters in molded parts, require separate sterilization processes (e.g., gamma radiation) that are not compatible with certain fluids, provide production rates limited to approximately nine thousand (9,000) non-sterile units per hour, and can be provided to an end-user for approximately one dollar and forty cents ($1.40) per dose/unit.

Inspection of BFS products such as BFS vials, bottles, cards, etc., that are filled with therapeutic, biologic, medicinal, and/or other injectable fluids, presents challenges that are not addressed by previous inspection systems.

### SUMMARY

Embodiments of the disclosed subject matter provide systems and methods for inspecting a pre-filled blow-fill-seal (BFS) product. For example, in embodiments, the BFS product can include a plurality of BFS vials formed together during a BFS manufacturing process. Each BFS vial can have a neck with a coupling portion that is used to secure and seal an administration assembly to the BFS vial for subsequent use. In some embodiments, proper operation of the BFS assembly (e.g., avoiding leakage between the neck and the administration assembly) may be influenced by the configuration of the neck and/or the coupling portion. The neck can thus be inspected after manufacturing, for example, to determine proper shape and size of the coupling portion.

While conventional methods for inspection (e.g., machine vision) may have issues inspecting such necks, embodiments of the disclosed subject matter can perform inspection using a unique illumination and detection configuration, which allows imaging of the BFS vial neck despite being formed of a translucent plastic. Other features of the BFS product and/or BFS vials can also be inspected, such as, but not limited to, a tab (e.g., including printed or embossed information), a reservoir (e.g., particular within a liquid product sealed within the reservoir), fluid seal of neck (e.g., shape of fluid seal, or defect therein), or a product body (e.g., shape of shoulder, particulate within body).

In some embodiments, all of the BFS vials of the BFS product are inspected to determine compliance of the BFS product. Alternatively, in some embodiments, only one or some of the BFS vials (e.g., only the laterally outer vials) are inspected to determine compliance of the BFS product (e.g., the compliance determination may be imputed to all of the BFS vials of the BFS product even if not specifically inspected). Alternatively or additionally, in some embodiments, only one or some of the BFS products are inspected for compliance, for example, a periodic or random inspection for quality control.

In one or more embodiments, an inspection system for a pre-filled BFS product can comprise one or more first inspection stations and a controller operatively coupled thereto. The BFS product can have first and second ends spaced from each other along a longitudinal direction. The BFS product can comprise one or more necks at the first end that extend along the longitudinal direction. Each neck can comprise a coupling portion that protrudes laterally outward with respect to adjacent portions of the neck. Each first inspection station can comprise an illumination assembly and a detection assembly. The illumination assembly can comprise one or more light sources and can be constructed such that interrogating light from the light sources is directed at a perimeter of a coupling portion of a neck disposed at a target position. The detection assembly can comprise one or more imaging devices. The detection assembly can have an input optical axis extending from the target position along the longitudinal direction and can be arranged to detect light emitted from the neck disposed at the target position. The controller can be configured to determine compliance of the BFS product with respect to one or more predetermined criteria based at least in part on the light detected by the one or more imaging devices.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Where applicable, some elements may be simplified or otherwise not illustrated in order to assist in the illustration and description of underlying features. For example, in some figures, some components have been illustrated using a partial or cutaway view in order to illustrate internal interaction of components. Throughout the figures, like reference numerals denote like elements. An understanding of embodiments described herein and many of the attendant advantages thereof may be readily obtained by reference to the following detailed description when considered with the accompanying drawings, wherein:

FIGS. 1A-1B are perspective views of a medical delivery assembly in an unassembled configuration, according to one or more embodiments of the disclosed subject matter;

FIGS. 1C-D are perspective and cross-sectional views, respectively, of the medical delivery assembly of FIGS. 1A-1B in an assembled configuration;

FIGS. 2A-2B are front and side views, respectively, of an exemplary pre-filled blow-fill-seal (BFS) vial for use in a medical delivery assembly, according to one or more embodiments of the disclosed subject matter;

FIGS. 2C-2D are front and side views, respectively, of another exemplary pre-filled BFS vial for use in a medical delivery assembly, according to one or more embodiments of the disclosed subject matter;

FIG. 3A is a simplified schematic diagram of an exemplary system for fabricating and inspecting BFS vials, according to one or more embodiments of the disclosed subject matter;

FIG. 3B is a simplified schematic diagram showing a side view of an exemplary illumination and detection setup for inspecting a neck of a BFS vial, according to one or more embodiments of the disclosed subject matter;

FIG. 3C is a simplified schematic diagram showing a bottom view of another exemplary illumination and detection setup for inspecting a neck of a BFS vial, according to one or more embodiments of the disclosed subject matter;

FIGS. 3D-3E are simplified schematic diagrams showing side and bottom views, respectively, of another exemplary illumination and detection setup for inspecting a neck of a BFS vial, according to one or more embodiments of the disclosed subject matter;

FIG. 4 is a process flow diagram of an exemplary method for inspecting a neck of a BFS vial, according to one or more embodiments of the disclosed subject matter;

FIG. 5 is side view of a manufactured BFS product comprised of a plurality of pre-filled BFS vials, according to one or more embodiments of the disclosed subject matter.

FIG. 6 is a process flow diagram of an exemplary method for inspecting a manufactured BFS product, according to one or more embodiments of the disclosed subject matter;

FIG. 7A is a side perspective view of an exemplary system for inspection of BFS products, according to one or more embodiments of the disclosed subject matter;

FIGS. 7B-7C are perspective and detail views, respectively, of a user interface of the BFS product inspection system of FIG. 7A;

FIGS. 7D-7E are top perspective and detail views, respectively, of exemplary stations within the BFS product inspection system of FIG. 7A;

FIGS. 7F-7G are partial perspective views of an infeed end and an outfeed end, respectively, of the BFS product inspection system of FIG. 7A;

FIG. 8A is a sectional perspective view illustrating aspects of an infeed drive section in a BFS product inspection system, according to one or more embodiments of the disclosed subject matter;

FIG. 8B is a close-up perspective view of an exemplary first drive mechanism for transporting a BFS product, according to one or more embodiments of the disclosed subject matter;

FIG. 8C is a simplified cross-sectional view illustrating support of a BFS vial by the first drive mechanism of FIG. 8B;

FIG. 8D is a close-up perspective view of an exemplary tab inspection station, according to one or more embodiments of the disclosed subject matter;

FIG. 8E is a close-up perspective view of an exemplary neck inspection station, according to one or more embodiments of the disclosed subject matter;

FIG. 8F is a close-up perspective view illustrating handover from the first drive mechanism to an exemplary second drive mechanism for transporting a BFS product, according to one or more embodiments of the disclosed subject matter;

FIG. 8G is a simplified cross-sectional view illustrating support of a BFS vial by the second drive mechanism of FIG. 8F;

FIG. 8H is a close-up perspective view of an exemplary body inspection station, according to one or more embodiments of the disclosed subject matter;

FIG. 8I is a close-up perspective view of an exemplary selectable drive mechanisms for directing a BFS product along rejection output paths, according to one or more embodiments of the disclosed subject matter;

FIG. 8J is a close-up perspective view of an exemplary outfeed drive mechanism for transporting a BFS product from the inspection system according to one or more embodiments of the disclosed subject matter;

FIG. 9A is a sectional perspective view illustrating aspects of an infeed drive section in another exemplary BFS product inspection system, according to one or more embodiments of the disclosed subject matter;

FIG. 9B is a close-up perspective view of another exemplary first drive mechanism for transporting a BFS product, according to one or more embodiments of the disclosed subject matter;

FIG. 9C is a simplified cross-sectional view illustrating support of a BFS vial by the first drive mechanism of FIG. 9B;

FIG. 9D is a close-up perspective view of another exemplary tab inspection station, according to one or more embodiments of the disclosed subject matter;

FIG. 9E is a simplified cross-sectional view illustrating support of a BFS vial by the second drive mechanism of FIG. 9F;

FIG. 9F is a close-up perspective view illustrating handover from the first drive mechanism of FIG. 9C to an exemplary second drive mechanism for transporting a BFS product, according to one or more embodiments of the disclosed subject matter;

FIG. 9G is a close-up perspective view of another exemplary body inspection station, according to one or more embodiments of the disclosed subject matter;

FIG. 9H is a close-up perspective view of another exemplary selectable drive mechanisms for directing a BFS product along rejection output paths, according to one or more embodiments of the disclosed subject matter;

FIG. 10A shows an exemplary image of a neck of a BFS vial obtained by a neck inspection station, according to or one or more embodiments of the disclosed subject matter;

FIG. 10B shows an exemplary image of a body of a BFS product obtained by a body inspection station, according to one or more embodiments of the disclosed subject matter; and

FIG. 11 depicts a generalized example of a computing environment in which the disclosed technologies may be implemented.

### DETAILED DESCRIPTION

### I. Introduction

Described herein are systems, assemblies, and methods for inspecting pre-filled medical delivery assemblies. In some embodiments, the medical delivery assemblies include at least one blow-fill-seal (BFS) vial (also referred to herein as a component, container, or bottle) that has one or more reservoirs (also referred to herein as chambers) prefilled with one or more liquid agents using a BFS manufacturing technique. The reservoirs filled with the liquid agents can be sealed from the environment until dispensing thereof is desired (e.g., a time for administration to the patient). The BFS vial may be constructed, filled, and sealed, according to some embodiments, in a sterile manufacturing environment. In some embodiments, multiple BFS vials can be simultaneously formed together as a single BFS product (also referred to herein as a module or card), which can then be separated into subsets or individual BFS vials for subsequent storage and/or use. BFS vials may, for example, offer a less expensive alternative to typical vials or bottles created via other manufacturing techniques.

In some embodiments, BFS modules (e.g., due to the nature of the BFS manufacturing process) may not require separate sterilization (and thereby may be compatible with a wider array of liquid agents), may provide enhanced production rates of sterile/aseptic units per hour, and/or may be provided to an end-user for significantly lower per dose/unit costs. In some embodiments, these advantages may come with an attendant drawbacks of reduced manufacturing tolerances and other disadvantages of utilizing a “soft” plastic (e.g., having a Shore/Durometer “D” hardness of between 60 and 70). BFS processes may, for example, offer less precise manufacturing tolerances in the range of five hundredths of an inch (0.05-in; 1.27 mm) to fifteen hundredths of an inch (0.15-in; 3.81 mm)—for linear dimensions, e.g., in accordance with the standard ISO 2768-1 “General tolerances for linear and angular dimensions without individual tolerance indications” published by the International Organization for Standardization (ISO) of Geneva, Switzerland (Nov. 15, 1989), which is incorporated herein by reference.

### II. BFS Vials

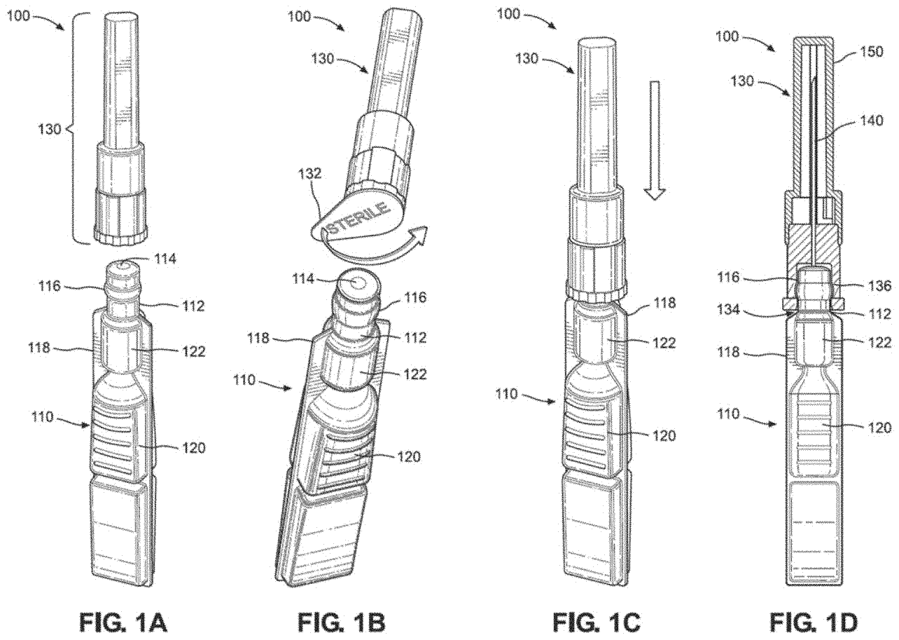

Referring initially to FIGS. 1A-1D, various views of a pre-filled medical delivery assembly 100 according to some embodiments are shown. In some embodiments, the pre-filled medical delivery assembly 100 may comprise various inter-connected and/or modular components, such as a BFS vial 110 comprising and/or defining a vial neck 112, a fluid seal 114, a coupling portion 116 (also referred to herein as a mounting portion, collar, or flange), and/or one or more reservoirs 120, 122. In some embodiments, the BFS vial 110 may also comprise a body flange 118 (also referred to herein as a bottle flange or interconnecting web), which may, for example, comprise unmolded portions of fused parison. In some embodiments, the body flange 118 connects the BFS vial 110 to adjacent vials simultaneously formed by a BFS manufacturing process.

In some embodiments, the BFS vial 110 may also comprise and/or define a tab 126 upon and/or in which various identifying information (e.g., descriptive of the fluid agent contained within the vial) is provided. For example, the identifying information may comprise various printed, engraved (e.g., laser engraved), embossed, adhered, radio-frequency identification (RFID), quick response (QR) code, barcode, and/or other informational objects (human and/or computer-readable) that are indicative of one or more characteristics of the vial, a product card of which the vial was a part, the manufacturing process/device/location, and/or the fluid agent(s). In some embodiments, the identifying information may comprise first information disposed on a first side or face of the tabs 126 (e.g., the front side as shown in FIG. 1A) and/or second information disposed on a second side or face of the tabs 126 (not shown in FIG. 1A).

In some embodiments, the pre-filled medical delivery assembly 100 may comprise an administration module or component 130 that is, e.g., maintained as a closed and/or sterile component via a seal 132 (e.g., a foil, wax, paper, and/or other thin, pierceable, tear-able, and/or removable object or layer coupled to the administration component 130) that seals an interior volume of hub 134 disposed at a first end thereof. According to some embodiments, the hub 134 may comprise and/or define (e.g., on or in an interior surface thereof) a shaped seat 136 that is configured to accept the coupling portion 116 of the BFS vial 110 (e.g., in the case that the neck 112 of the BFS vial 110 is inserted into the hub 134). In some embodiments, the administration component 130 may comprise and/or be coupled to an administration member 140 (e.g., a cannula or needle). In some embodiments, the administration member 140 can be inserted into and/or extend through the hub 134, for example, such that it comprises a first or administration end extending longitudinally distal from the BFS vial 110 and a second end disposed within the hub 134 and/or extending into the BFS vial (e.g., in the case that the vial 110 is coupled to the hub 134). In some embodiments, the administration end and/or a distal portion of the administration member 140 may be housed, shrouded, and/or covered by a cap 150, which may be removably coupled to the hub 134 (e.g., via friction fit with an external portion of the hub).

In some embodiments, the administration member 140 may comprise a needle for at least one of subcutaneous, intramuscular, intradermal, and intravenous injection of the fluid agent into the patient. For example, the needle can have a length of 0.5 mm to 4 mm, inclusive, or in a range of 4 mm to 15 mm, inclusive, or in a range of 15 mm to 30 mm, inclusive, depending on the desired manner of injection. For ease of explanation and description, the figures and the description herein generally refer to the administration member as a needle. However, it should be noted that, in other embodiments, the administration member 140 may include a nozzle (not shown) configured to control administration of the fluid agent to the patient. The nozzle may include a spray nozzle, for example, configured to facilitate dispersion of the fluid agent into a spray. Accordingly, a hub 134 fitted with a spray nozzle may be particularly useful in the administration of a fluid agent into the nasal passage, for example, or other parts of the body that benefit from a spray application (e.g., ear canal, other orifices). In other embodiments, the nozzle may be configured to facilitate formation of droplets of the fluid agent. Thus, a hub 134 including a droplet nozzle may be useful in the administration of a fluid agent by way of droplets, such as administration to the eyes, topical administration, and the like.

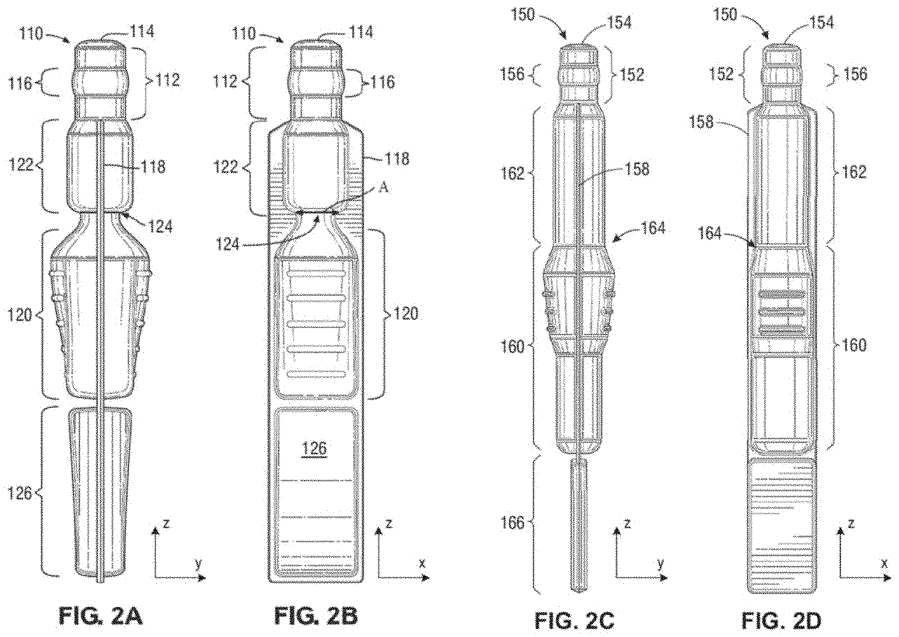

In the illustrated example of FIGS. 1A-1D and 2A-2B, the BFS vial 110 may comprise and/or define a neck 112 that terminates at fluid seal 114 disposed at a first end of the vial 110. For example, the fluid seal 114 may comprise a portion of the molded BFS vial 110 that is configured to be pierced to expel the fluid, e.g., such as by providing a flat or planar piercing surface and/or by being oriented normal to an axis (e.g., longitudinal direction, z) of the BFS vial 110 (and/or the pre-filled medical delivery assembly 100). In some embodiments, the fluid seal 114 may comprise a foil, wax, paper, and/or other thin, pierceable object or layer coupled to the BFS vial 110. In some embodiments, the neck 112 may comprise and/or define coupling portion 116. For example, the coupling portion 116 can be formed as an axially-elongated and/or rounded exterior flange or projection, e.g., the “doughnut”-shaped or toroidal-shaped exterior flange depicted. The coupling portion 116 may, for example, provide a radially-elastic mating surface that is operable to provide a selective engagement or fit within the hub 134 of the administration component 130.

In some embodiments, the one or more reservoirs 120, 122 may be filled (fully or partially) with a fluid or other agent (not separately shown) to be delivered, e.g., to a patient (not shown). According to some embodiments, the fluid may be injected into the BFS vial 110 during manufacture via a BFS process (e.g., in a sterile environment) and sealed within the BFS vial 110 via the fluid seal 114. In some embodiments, the reservoirs 120, 122 may be joined by a constriction 124 (also referred to herein as a passage, juncture, junction, depression, indentation, relief, geometric transition, grip point, valve, restriction, or narrowed portion), as shown in FIGS. 1A-1D and 2A-2B. According to some embodiments, the constriction 124 can restrict flow such that the fluid may readily enter one of the dispensing reservoirs 122 and the collapsible reservoir 120, but may not readily return to the other reservoir 120, 122. Such a constriction may in some embodiments, provided advantages as described in International Publication No. WO 2021/207040, published Oct. 14, 2021 and titled “Systems and Methods for Pre-filled Medical Delivery,” which is incorporated by reference herein in its entirety. Alternatively, in some embodiments, the BFS vial can be provided with a single reservoir or multiple reservoirs without a corresponding constriction between the reservoirs. For example, FIGS. 2C-2D illustrate such a BFS vial 150 comprising and/or defining a vial neck 152, a fluid seal 154, a coupling portion 156, a body flange 158, a first reservoir 160, and a second reservoir 162. As shown in FIGS. 2C-2D, the connection 164 between the first and second reservoirs 160, 162 can be joined without any constriction.

As generally understood, the fluid or drug agent sealed within the BFS vial 110 (or BFS vial 150) may include any type of agent to be injected into a patient (e.g., mammal, either human or non-human, or any other animal) and capable of producing an effect (alone, or in combination with an active ingredient). Accordingly, the agent may include, but is not limited to, a vaccine, a drug, a therapeutic agent, a medicament, a diluent, and/or the like. According to some embodiments, either or both of the fluid agent and the active ingredient (i.e., the drug agent and/or components thereof) may be tracked, monitored, checked for compatibility with each other, etc., such as by utilization of electronic data storage devices (not shown) coupled to the various modules or components of the pre-filled multi-liquid medical delivery assembly, such as the BFS vial 110 and/or administration component 130.

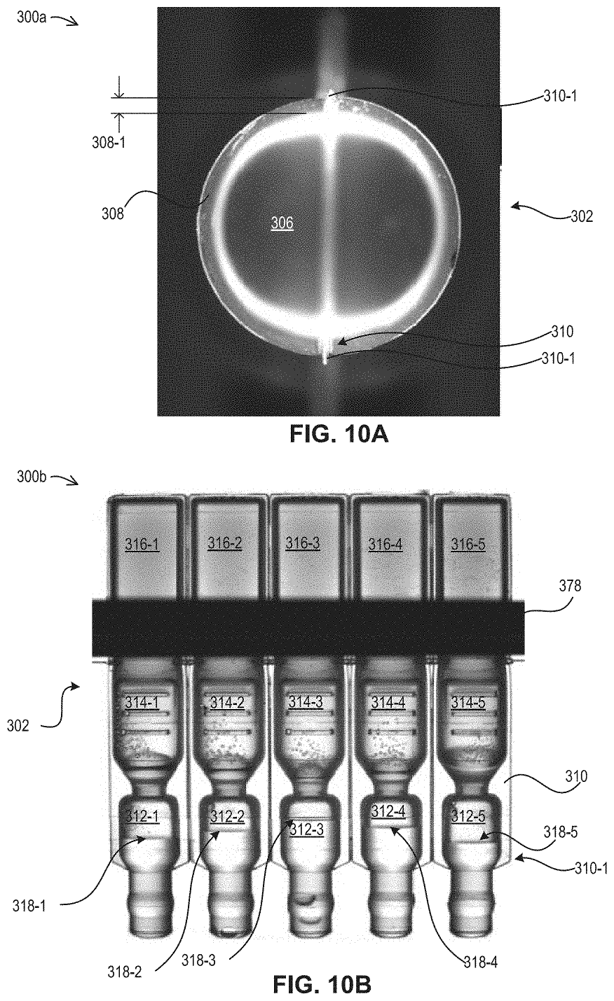

In some embodiments, the BFS vial 110 and administration assembly 130 may be coupled, e.g., in the field and/or in situ, to provide an active pre-filled (e.g., injectable) medical delivery assembly 100. As shown in FIG. 1B, for example, the seal 132 may be removed from the administration component 130 and the administration component 130 (and/or the hub 134 thereof) may be aligned with the neck 112 of the BFS vial 110. According to some embodiments, the administration component 130 may be axially engaged to couple with the BFS vial 110 via application of a mating axial force, as shown in FIG. 10. The administration component 130 may be urged onto the neck 112 of the BFS vial 110, for example, such that the cooperatively shaped seat 136 (e.g., an interior groove) accepts the coupling portion 116, thereby selectively and/or removably coupling the BFS vial 110 and the administration component 130. In some embodiments, the coupling portion 116 may be shaped as an axially-elongated rounded exterior flange (e.g., the toroidal shape as depicted) and/or the shaped seat 136 may comprise a cooperative and/or mirrored axially-elongated rounded interior groove or track.

As depicted in FIG. 1D, for example, the neck 112 of the BFS vial 110 may be urged and/or forced into the hub 134 until the coupling portion 116 becomes seated in (and/or coupled to and/or mated with) the shaped seat 136 (e.g., a seated position). In such a manner, the fluid seal 114 may be advantageously positioned adjacent to the needle 140 and/or may be engaged with the needle 140. In some embodiments, advancement of the neck 112 of the BFS vial 110 into the hub 134 through to the seated position may cause the needle 140 to pierce the fluid seal 114. According to some embodiments, the coupling portion 116 may be configured as the doughnut shape (as depicted) to provide various advantages to the pre-filled medical delivery assembly 100. The axial elongation of the coupling portion 116 may, for example, provide for a smooth, uniform, and/or less forceful mating process that is less likely to deform the soft plastic neck 112 of the BFS vial 110 and/or may provide for a lengthened mating surface that is more likely to prevent leakage of the fluid. In some embodiments, the coupling portion 116 and the cooperatively shaped and sized shaped seat 136 may permit simple, effective, reliable, and/or economic attachment of the needle 140 to the BFS vial 110.

Alternatively, in some embodiments, the neck of the BFS vial can be provided with a coupling portion (or mounting flange) constructed for interfacing with threads in the hub to secure the BFS vial to the administration assembly. For example, in place of or in addition to coupling portion 116 in neck 112 of BFS vial 110 (or coupling portion 156 in neck 152 of BFS vial 150), the coupling portion of the BFS vial can define and/or comprise an external thread element (e.g., one or more Luer-style thread protrusions). In some embodiments, the external thread element can be constructed as an angled exterior flange designed to fit within a cooperative and/or mirrored angled interior groove or track within the hub.

In some embodiments, the administration component 130 (and/or the cap 150) may be composed of a medical grade material. In some embodiments, the administration component 130 (and/or the cap 150) may be composed of a thermoplastic polymer or other relatively hard plastic (e.g., greater than 80 on the Rockwell “M” scale; e.g., Rockwell M 85; and/or greater than 110 on the Rockwell “M” scale; e.g., Rockwell R 115), such as, but not limited to, polypropylene, polybenzimidazole, acrylonitrile butadiene styrene (ABS), polystyrene, polyvinyl chloride, polycarbonate, or the like. In some embodiments, the pre-filled medical delivery assembly 100 may be advantageously manufactured (in mass quantities) in separate parts or portions, namely, at least the “soft” plastic BFS vial 110 portion (e.g., a “first” piece) and the “hard” plastic administration component 130 (e.g., the “second” piece), with such different plastic parts/portions being selectively coupled to administer a medication to a patient.

In some embodiments, fewer or more components 110-166 and/or various configurations of the depicted components 110-166 may be included in the pre-filled medical delivery assembly 100 without deviating from the scope of embodiments described herein. In some embodiments, the components 110-166 may be similar in configuration and/or functionality to similarly named and/or numbered components as described herein. According to some embodiments, the pre-filled medical delivery assembly 100 may comprise the coupling portion 116 but not the collapsible reservoir 120. In some embodiments, the pre-filled medical delivery assembly 100 may comprise the coupling portion 116 but not the dispensing reservoir 122.

### III. Inspection of BFS Products

Each BFS vial can have a neck with a coupling portion that is used to secure and seal an administration assembly to the BFS vial for subsequent use. In some embodiments, proper operation of the BFS assembly (e.g., avoiding leakage between the neck and the administration assembly) may be influenced by the configuration of the neck and/or the coupling portion. The neck can thus be inspected after manufacturing, for example, to determine proper shape and size of the coupling portion, among other features. While conventional methods for inspection (e.g., machine vision) may have issues inspecting such necks, embodiments of the disclosed subject matter can perform inspection using a unique illumination and detection configuration, which allows imaging of the BFS vial neck despite being formed of a translucent plastic. Other features of the BFS product and/or BFS vials can also be inspected, such as, but not limited to, a tab (e.g., including printed or embossed information), a reservoir (e.g., particular within a liquid product sealed within the reservoir), fluid seal of neck (e.g., shape of fluid seal, or defect therein), or a product body (e.g., shape of shoulder, particulate within body).

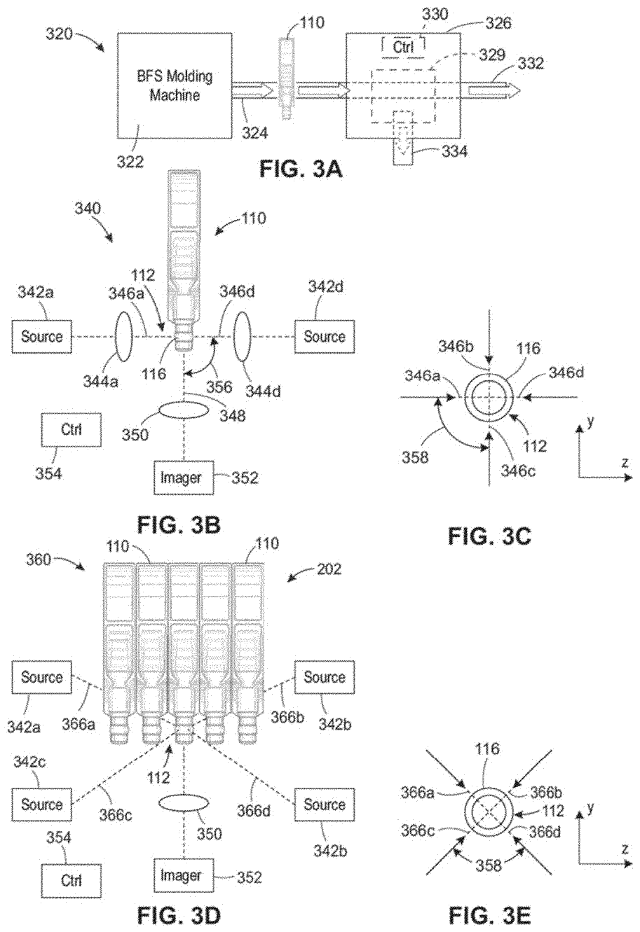

FIG. 3A illustrates certain aspects of a system 320 for manufacturing and inspecting a BFS vial, such as BFS vial 110. In some embodiments, system 320 can include a BFS molding machine (e.g., a BFS shuttling machine or a BFS rotary machine) and a BFS product inspection system 326. In some embodiments, additional machine or systems can be disposed before, between, or after the BFS molding machine 322 and/or the BFS product inspection system 326, such as, but not limited to, a label creation station (e.g., laser-etching of and/or adhesive label fixing on tabs 126), punching station (e.g., to trim excess plastic), card separation station (e.g., where a larger BFS product is separated into smaller constituent cards of multiple vials), and/or a packaging station (e.g., where the BFS product is enclosed in a package for subsequent transport, storage, and/or use). In some embodiments, a first conveyor system or drive 324 can connect an output of the BFS molding machine 322 to an input of the BFS product inspection system 326.

In some embodiments, the inspection system 326 can comprise one or more inspection stations 328, for example, at least one station for inspecting a neck of BFS vial 110. A controller 330 can be operatively coupled to the inspection station 328 for controlling operation thereof. Alternatively or additionally, in some embodiments, the controller 330 is coupled to the inspection station 328 to receive one or more signals from the inspection station 328 indicative of a result of the inspection and/or one or more data signals (e.g., providing information that can be used by the controller 330 to form an image and to perform a comparison with predetermined criteria). In some embodiments, the controller 330 can be configured to control transport of the BFS vial 110 through the inspection system 326 based at least in part on a result of the inspection. For example, in some embodiments, if the inspection by station 328 indicates that the BFS vial 110 does not comply with one or more predetermined criteria (e.g., as determined by the inspection station 328 and/or controller 330), the controller 330 can redirect the BFS vial 110 to move along a rejection path 334 rather than via output path 332.

In some embodiments, inspection of the neck of the BFS vial 110, in particular a coupling portion thereof, may be complicated due to the translucent nature of the plastic comprising the BFS vial and the relatively small sizes of the BFS vial features being inspected (e.g., a neck diameter of 6.5-6.65 mm and/or a protrusion amount of the coupling portion from the neck of 0.8-1.6 mm), especially if axial lighting (e.g., directed along longitudinal direction, z) and axial detection (e.g., with an input optical axis extending along longitudinal direction, z) are both used to image the BFS vial 110. Accordingly, in some embodiments, angled lighting can be employed together with axial detection, which may allow for the capture of images that have a resolution conducive to image analysis processing.

For example, FIG. 3B shows an exemplary setup 340 for a neck inspection station employing such a configuration. The setup 340 can include an illumination assembly and a detection assembly. In some embodiments, the detection assembly can comprise one or more imaging devices 352 (e.g., a camera or other 2-D photodetector array, such as a complementary metal-oxide semiconductor (CMOS) or charge-coupled device (CCD)). In some embodiments, the detection assembly can have an input optical axis 348 (e.g., defined by one or more optical components, such as lens 350) extending from a target position at which neck 112 is disposed for inspection. In some embodiments, the input optical axis 348 can be collinear with a longitudinal axis of the BFS vial 110, or at least substantially parallel to the longitudinal axis of the BFS vial 110. In the illustrated example, the imaging device 352 is also aligned with the longitudinal axis of the BFS vial 110 (e.g., with a detection face of the imaging device 352 substantially perpendicular to input optical axis 348 and BFS vial longitudinal axis); however, in some embodiments, the imaging device 352 can have a different orientation, for example, where a mirror or other optical element redirects light from input optical axis 348 at an angle toward the imaging device 352. In some embodiments, a controller 354 is configured to receive one or more signals from the imaging device 352 indicative of an image obtained of the neck 112 and/or one or more data signals (e.g., providing information that can be used by the controller 354 to form an image and to perform a comparison with predetermined criteria).

In some embodiments, the illumination assembly can comprise one or more light sources (or lighting devices), for example, four light sources 342a-342d, for example, arranged at equal intervals (e.g., to form angle 358 between adjacent light paths 346a-346d of)—90° around the perimeter of the neck 112 of the BFS vial, as shown in FIGS. 3B-3C. For example, in some embodiments, light sources 342a, 342d can be arranged to direct interrogating light (e.g., light directed along paths 346a, 346d, respectively) along a first lateral direction (e.g., x-direction), which may be on a parting line plane of the BFS vial 110. In some embodiments, the other light sources can be arranged to direct interrogating light (e.g., light directed along paths 346b, 346c, respectively) along a second lateral direction (e.g., y-direction), which may be on a plane perpendicular to the front and back faces of the BFS vial 110.

In some embodiments, each light source 342a-342d can have one or more optical components 344a-344d that direct the interrogating light along the appropriate path 346a-346d toward the neck 112. For example, the one or more optical components 344a-344d can comprise a light tube (or pipe), an optical fiber, a lens, a filter, a reflector, or any combination thereof. In some embodiments, the interrogating light can have one or more wavelengths in a range from 10 nm to 1 mm inclusive, for example, in a range from 400-700 nm (e.g. visible light). In some embodiments, each light source 342a-342d can comprise a laser source, a laser diode, or a light emitting diode (LED).

In the illustrated example, the interrogating light from light sources 342a-342d can be directed to provide lateral plane illumination (e.g., substantially parallel to x-y plane) and/or can be directed substantially along a radial direction of the coupling portion 116. For example, paths 346a-346d of the interrogating light can be directed along a plane substantially perpendicular to the longitudinal direction and/or the input optical axis 348 of the detection assembly. In some embodiments, the paths 346a-346d of the interrogating light can thus form an angle 356 with the input optical axis 348 of −90°. Alternatively or additionally, in some embodiments, the light paths 346a-346d can be directed at an angle away from the longitudinal axis (e.g., the axial direction and/or vertical direction), such that light from the light sources cannot directly enter an input aperture of the detection optical assembly and/or such that only light scattered or reflected by the neck 112 enters input aperture and is detected by imaging device 352. For example, in some embodiments, the paths 346a-346d can be directed at an angle with respect to the lateral plane, but such that a major component of the light along the lateral direction exceeds the components of the light along the longitudinal direction. For example, in some embodiments, the paths 346a-346d of the interrogating light can form an angle 356 with the input optical axis 348 that is less than or equal to 135°.

In the illustrated example of FIGS. 3B-3C, the light paths 346a and 346d are aligned with the parting line of the BFS vial 110. However, when a BFS product is provided with multiple BFS vials 110 coupled together, the laterally-adjacent BFS vials may obstruct such light paths 346a, 346d and/or movement of the BFS product may be obstructed. Accordingly, in some embodiments, the light paths can be disposed at an angle with respect to and/or away from the BFS vial parting plane. For example, FIGS. 3D-3E illustrate another exemplary setup 360 for a neck inspection station to inspect a BFS product 202 having a plurality of BFS vials 110, where the light sources 342a-342d have been reoriented such that respective light paths 366a-366d can interrogate neck 112 at a target location without obstruction or interference by adjacent BFS vials of the BFS product 202. Other configurations and/or orientations for the light sources and/or light paths are also possible according to one or more contemplated embodiments.

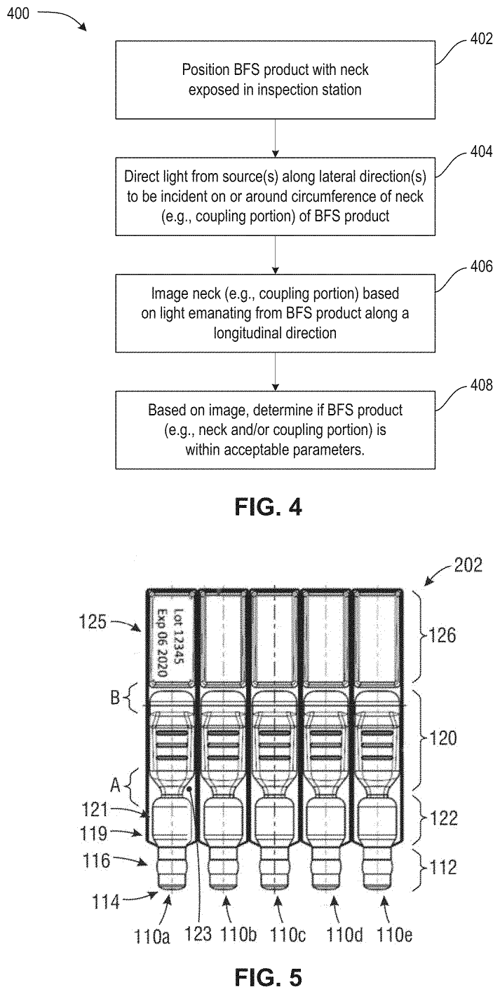

FIG. 4 shows an exemplary method 400 for inspecting the neck of a BFS vial, such as vial 110 or vial 150. The method 400 can initiate at process block 402, where a neck of the BFS vial is positioned at a target position within an inspection station. In some embodiments, the BFS vial is supported such that the neck of the BFS vial is exposed, for example, with the supporting infrastructure grasping or otherwise contacting portions of the vial spaced away from the neck along the longitudinal direction (e.g., at a fluid reservoir, at a constriction between axially-adjacent fluid reservoirs, or at a narrowed region between a tab and a reservoir of the BFS vial). In some embodiments, the BFS vial can be conveyed through the target position while the inspection is performed. Alternatively, in some embodiments, the BFS vial can be stationary within the target position during all or part of the inspection.

The method 400 can proceed to process block 404, where interrogating light can be directed onto or surrounding the neck of the BFS vial at the target position. For example, the interrogating light can be directed at the coupling portion of the neck, or at other portions of the neck proximal to the coupling portion. In some embodiments, the interrogating light can be directed along lateral directions (e.g., substantially along a radial direction of the neck) so as to be incident on or around the circumference or perimeter of the coupling portion of the neck, for example, as described herein. In some embodiments, the interrogating light is provided by an illumination assembly with one or more lights sources.

The method 400 can proceed to process block 406, where the light emanating or emitted from the BFS vial is detected. For example, in some embodiments, a detection optical assembly, which has an input optical axis extending from a target position along the longitudinal direction, can be used to detect the light from the BFS vial. The detection optical assembly can thus be arranged to collect and detect light that has been emitted axially from the BFS vial in response to the illumination of process block 404. In some embodiments, an axial image of at least the coupling portion (and optionally other portions of the neck, such as the end seal) is formed based on the detected light from the BFS vial.

The method 400 can proceed to process block 408, where it is determined if at least the coupling portion (and optionally other portions of the BFS vial) is within acceptable parameters (e.g., compliant with one or more predetermined criteria). For example, in some embodiments, various shapes, orientations, sizes, and/or other features of the coupling portion and/or neck of the BFS vial in the obtained image may be compared to stored images, templates, geometries, dimensions, etc. to determine whether the inspected BFS vial falls within acceptable parameters. Based on the determination of process block 408, the method can perform an action indicative of the determination, for example, by providing a visual or audible alarm, by automatically routing non-compliant or defective BFS vials, by automatically routing compliant or acceptable BFS vials, and/or by providing feedback to a BFS molding machine to automatically adjust parameters thereof to obtain more compliant BFS vials. In some embodiments, the determination of process block 408 can take into account multiple inspections of different BFS vials. For example, an inspection system can evaluate multiple BFS vials or products produced by a BFS molding machine and can identify failure trends that may indicate a problem with molding or other aspects of the BFS product fabrication. In some embodiments, feedback based on the identified trends can be sent to one or more upstream fabrication systems, for example, to generate an alarm or halt production to address the problem.

Although some of blocks 402-408 of method 400 have been described as being performed once, in some embodiments, multiple repetitions of a particular process block may be employed before proceeding to the next decision block or process block. In addition, although blocks 408-408 of method 400 have been separately illustrated and described, in some embodiments, process blocks may be combined and performed together (simultaneously or sequentially). For example, the illumination of process block 404 may generally occur at the same time as the imaging in process block 406. Moreover, although FIG. 4 illustrates a particular order for blocks 404-408, embodiments of the disclosed subject matter are not limited thereto. Indeed, in certain embodiments, the blocks may occur in a different order than illustrated or without other blocks. For example, in some embodiments, only one or some BFS vials (e.g., one or some BFS vials of a single BFS product card, or one or some BFS vials of different BFS product cards, or one or some separate BFS vials) may be subject to inspection. For example, in some embodiments, a subset of BFS products produced by a BFS molding process can be periodically or randomly selected for inspection, but not all of the produced BFS products may be subject to inspection and/or not subject to the same inspection.

Referring to FIG. 5, a front view of a pre-filled BFS product card 202 according to some embodiments is shown. In some embodiments, the pre-filled BFS product card 202 may comprise a plurality of interconnected or coupled BFS vials 110a-110e, each comprising and/or defining a respective neck 112 (e.g., generally cylindrical, as shown), each neck 112 comprising a corresponding fluid seal 114, and/or each neck 112 comprising and/or defining a corresponding coupling portion 116. According to some embodiments, the pre-filled BFS product card 202 may comprise a BFS-molded product that is extracted from a BFS mold and respective BFS machine (neither shown). In some embodiments, different BFS machines may produce pre-filled BFS product cards 202 with differing numbers of BFS vials, e.g., fewer or more than the five (5) BFS vials 110a-110e depicted in FIG. 5. According to some embodiments, more BFS vials than are depicted in FIG. 5 may be molded together (e.g., via a single molding stage) and may then be separated into multiple “cards” (e.g., the BFS product cards 202), with each such BFS product card comprising one or more BFS vials. According to some embodiments, a BFS machine may produce between fifteen (15) and twenty-five (25) BFS vials, which can then be segmented or cut into multiple BFS product cards. As depicted, for example, the BFS product card 202 that comprises the five (5) BFS vials 110a-110e may have been produced by cutting a fifteen (15)-vial product into three (3) equal segments or by cutting a twenty-five (25)-vial product into five (5) equal segments.

In some embodiments, each BFS vial 110a-110e may comprise and/or be interconnected with an adjacent BFS vial 110a-110e via plastic web 121, which may comprise, for example, unformed portions of plastic substrate utilized in the BFS manufacturing process. In some embodiments, after separation of the BFS vial from the BFS product card 102, the body flange 118 can be formed by severed or cut portions of the plastic web 121. According to some embodiments, the plastic web may be trimmed adjacent to each respective neck 112 to define a shoulder portion 119. In some embodiments, each neck 112 (or each internal void defined thereby; not separately labeled) may be in fluid communication with a respective fluid reservoir 122. According to some embodiments, the fluid reservoirs 122 and fluid seals 114 at a terminal end of each neck 112 may act to maintain any fluids (not explicitly shown) in the respective fluid reservoirs 122 and/or necks 112. In some embodiments, the fluid reservoirs 122 may be filled (fully or partially) with a fluid, liquid, or other agent (not separately shown in FIG. 1) to be delivered, e.g., to a patient (not shown).

According to some embodiments, each fluid reservoir 122 may be in fluid communication with a respective compressible reservoir 120. The compressible reservoirs 120 may, for example, retain a portion (some or all) of the fluid agent and/or may comprise a second fluid such as air. In some embodiments, a first junction “A” may be formed and/or defined between each fluid reservoir 122 and each respective compressible reservoir 120. According to some embodiments, a second junction “B” (e.g., a depression, indent, relief, geometric transition, grip point, etc.) may be formed and/or defined between each compressible reservoir 120 and each respective tab 126.

In some embodiments, the BFS product 202 can be subject to inspection for compliance, for example, with respect to one or more predetermined criteria. For example, the coupling portion 116 of one, some, or all of the BFS vials 110a-110e of the BFS product 202 can be checked for conformance to acceptable shapes, sizes, and/or ranges thereof. For example, the predetermined criteria can include an acceptable value or range of values for lateral dimension of the coupling portion 116, a lateral dimension of one of the adjacent portions of the neck 112, amount of lateral protrusion of the coupling portion 116 with respect to one of the adjacent portions of the neck (e.g., proximal to seal 114 and/or proximal to shoulder 119), a difference between lateral dimension of the coupling portion 116 and lateral dimension of one of the adjacent portions of the neck 112, or any combination of the foregoing.

In some embodiments, other portions of the BFS produce 202 besides the coupling portion can be inspected, for example, before or after inspection of the coupling portion 116. For example, the inspected features of the BFS product 202 can include, but are not limited to, (i) the shape and/or dimensions of the fluid reservoirs 122, (ii) the shape and/or dimensions of the shoulders 119, (iii) the shape and/or dimensions of the compressible reservoirs 120, (iv) whether any particles 123 are embedded in the plastic walls of the BFS product 202, (v) the opacity of the walls of the BFS product 202, (vi) whether any portions of the BFS product 202 are deformed, (vii) whether the edges of the BFS product 202 are properly punched/trimmed, (viii) whether the BFS product 202 comprises any excess plastic, and/or (ix) whether liquid is present in the BFS product 202 (e.g., in the fluid reservoirs 122 and/or necks 112). According to some embodiments, in the case that any data (or any amount of and/or type of data exceeding a stored threshold) does not fall within acceptable thresholds, the BFS product 202 may be rejected and/or flagged with a failure indication and/or status.

In some embodiments, only a portion of the BFS product 202 may be inspected (e.g., laterally-outermost BFS vials, such as leading vial 110a and/or trailing vial 110e). In such embodiments, the compliance results can be imputed to all of the vials 110a-110e in the BFS product 202, or the BFS product 202 can be flagged for more intensive inspection (e.g., of each vial). Alternatively or additionally, in some embodiments, each vial 110a-110e in the BFS product 202 can be inspected.

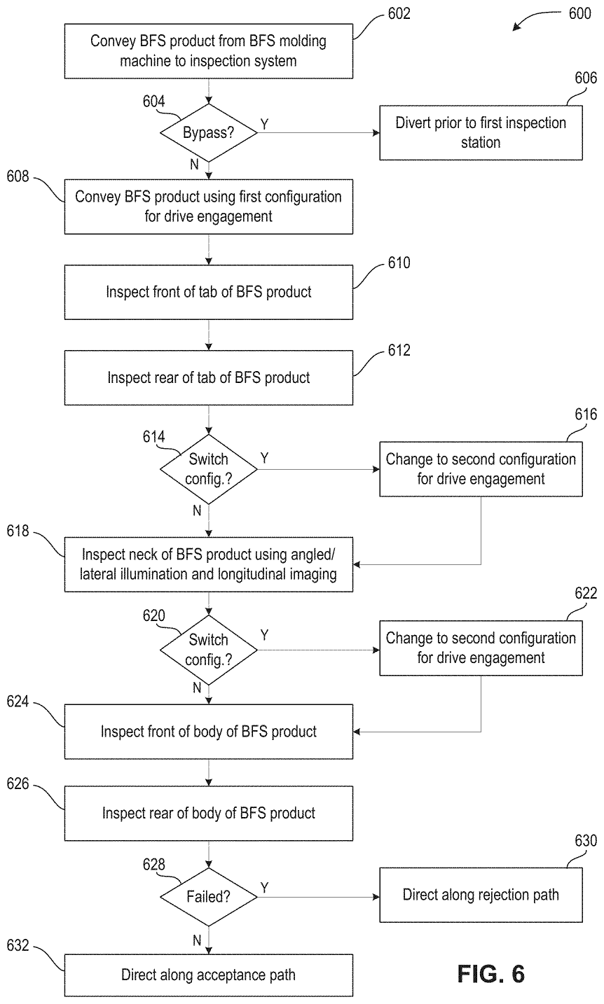

FIG. 6 shows an exemplary method 600 for inspecting a BFS product, such as product 202. The method 600 can initiate at process block 602, where a BFS product for inspection can be conveyed into a BFS inspection system. For example, in some embodiments, the BFS product can be received directly from a BFS molding machine (e.g., conveyed from a demolding stage of BFS shuttling machine or a BFS rotary machine) or indirectly from a BFS molding machine (e.g., via a post-processing station, such as label creation station (e.g., laser-etching of and/or adhesive label fixing on tabs 126), punching station (e.g., to trim excess plastic), and/or card separation station (e.g., where a larger BFS product is separated into smaller constituent cards of multiple vials)). Alternatively or additionally, the input into the BFS product inspection system can be via the outfeed of an interconnected upstream device (e.g., a BFS manufacturing machine) and/or via a manual feed mechanism.

In some embodiments, the conveying of process block 602 can be via or include an infeed conveyor or drive mechanism of the BFS inspection system. According to some embodiments, incoming BFS product may be directed to and/or accepted via a staged infeed. The speed of the infeed may be set and/or varied to ensure an adequate separation distance between BFS products traveling through the BFS product inspection system, for example. According to some embodiments, the BFS product inspection system may be in communication with upstream devices such that start, stop, alarm, and/or speed settings or other information is exchanged between interconnected devices to maintain coordination of the manufacturing, assembly, inspection, packaging, and/or distribution line.

The method 600 can proceed to decision block 604, where it is determined if the BFS product should bypass inspection. If bypass is desired, the method 600 can proceed to process block 606, where the BFS product can be diverted prior to any inspection. For example, BFS products may be selectively ejected by activation of a bypass ejection mechanism. In some embodiments, faulty BFS products and/or products that need to be excluded to maintain separation distances and/or other operations of the BFS product inspection system may, for example, be directed into a bypass line and/or bin at process block 604. For diverted BFS product, the inspection of method 600 may end, but the inspection of method 600 may otherwise continue for subsequent BFS products.

If no bypass is desired, the method 600 can proceed to process block 608, where the BFS product can be conveyed using a first configuration for drive engagement. For example, a drive mechanism can be used that grips or otherwise supports the BFS product while exposing at least the tab for inspection. For example, the drive mechanism can contact or engage with a constriction or junction between axially-adjacent reservoirs of one or more vials of the BFS product. Alternatively or additionally, the drive mechanism can contact or engage with opposing surfaces of reservoirs of one or more vials of the BFS product.

The method 600 can proceed to process block 610, where a front of a tab of the BFS module is inspected, for example, by conveying the BFS product through a first tab inspection station. For example, various markings, indicia, and/or other information descriptive of the BFS product and/or the fluid therein and that are disposed in or on a front tab (or other frontal element) of the BFS product may, for example, be sensed, read, captured, interpreted, decoded, and/or analyzed to determine if the information falls within acceptable parameters. According to some embodiments, the frontal tab inspection may comprise reading laser engraving markings on the front of the tab of the BFS product.

The method 600 can proceed to process block 612, where a rear of a tab of the BFS module is inspected, for example, by conveying the BFS module through a second tab inspection station. For example, various markings, indicia, and/or other information descriptive of the BFS product and/or the fluid therein and that are disposed in or on a rear tab (or other rear element) of the BFS product may, for example, be sensed, read, captured, interpreted, decoded, and/or analyzed to determine if the information falls within acceptable parameters. According to some embodiments, the rear tab inspection may comprise reading embossed markings on the rear of the tab of the BFS product.

The method 600 can proceed to decision block 614, where it is determined if the drive mechanism configuration should be changed, for example, to allow exposure of other portions of the BFS product that may otherwise by covered or obscured by the current drive mechanism configuration. If changing the drive mechanism configuration is desired, the method 600 can proceed to process block 616, where the drive mechanism configuration is changed. In some embodiments, the BFS product can be transferred from a current drive mechanism to a new drive mechanism via an overlapping handoff region. For example, the new drive mechanism can contact or engage with a constriction or narrowed region between the tab portion and a reservoir of one or more vials of the BFS product.

After process block 616, or after decision block 614 if no drive configuration change is desired, the method 600 can proceed to process block 618, where a neck of the BFS product can be inspected, for example, by conveying the BFS product through a neck inspection station. In some embodiments, an axially-oriented imaging and/or other sensor device (e.g., having an input optical axis substantially parallel to a longitudinal direction of the BFS product) may be utilized to capture information descriptive of the neck, seal, coupling portion, shoulder, and/or other features of the BFS vial. In some embodiments, and as described herein, such an inspection may be performed advantageously by utilizing angled lighting sources that direct light at or around the circumference of the neck and/or coupling portion—e.g., as opposed to from below or above (e.g., axially) the BFS product. According to some embodiments, various shapes, orientations, sizes, and/or other features of the neck area of the BFS product may be compared to stored images, templates, geometries, dimensions, etc. to determine whether the inspected BFS product falls within acceptable parameters.

The method 600 can proceed to decision block 620, where it is determined if the drive mechanism configuration should be changed, for example, to allow exposure of other portions of the BFS product that may otherwise by covered or obscured by the current drive mechanism configuration. If changing the drive mechanism configuration is desired, the method 600 can proceed to process block 622, where the drive mechanism configuration is changed. In some embodiments, the BFS product can be transferred from a current drive mechanism to a new drive mechanism via an overlapping handoff region. For example, the new drive mechanism can contact or engage with a constriction or narrowed region between the tab portion and a reservoir of one or more vials of the BFS product.

After process block 622, or after decision block 620 if no drive configuration change is desired, the method 600 can proceed to process block 624, where a front of a body of the BFS module is inspected, for example, by conveying the BFS product through a front body inspection process. For example, a frontal oriented imaging and/or other sensor device may be utilized to capture information descriptive of features of the front of the body of the BFS vial. In some embodiments, various shapes, orientations, sizes, and/or other features of the body of the BFS product may be compared to stored images, templates, geometries, dimensions, etc. to determine whether the inspected BFS product falls within acceptable parameters.

The method 600 can proceed to process block 626, where a rear of a body of the BFS module is inspected, for example, by conveying the BFS product through a rear body inspection process. For example, a rear oriented imaging and/or other sensor device may be utilized to capture information descriptive of features of the rear of the body of the BFS vial, for example. In some embodiments, various shapes, orientations, sizes, and/or other features of the body of the BFS product may be compared to stored images, templates, geometries, dimensions, etc. to determine whether the inspected BFS product falls within acceptable parameters. In some embodiments, the body of the BFS product (front and/or rear) may be inspected to identify and/or analyze the presence, amount, location, and/or other characteristics (e.g., color, viscosity) of the fluid agent within the BFS product.

The method 600 can proceed to decision block 628, where it is determined if the BFS product failed one or more aspects of inspection, for example, by being outside the bounds or otherwise non-compliant with one or more predetermined criteria. If the BFS product failed, the method 600 can proceed to process block 630, where the BFS product is redirected or diverted to follow a rejected product path. In some embodiments, the BFS product may be directed through a first reject gate, a second reject gate, or a third reject gate. Each reject gate may, for example, correspond to a different type of identified defect, problem, and/or failure reason or status. In some embodiments, each reject gate may be selectively activated by the BFS product inspection system to direct failed BFS products into appropriate reject areas, lines, bins, etc.

If the BFS product did not fail any inspection (or if the BFS product passes all, or more than a threshold amount, of the inspection processes), the method 600 can proceed to process block 632, where the BFS product is redirected or otherwise allowed to proceed along an output path, for example, via an outfeed conveyor. In some embodiments, the outfeed conveyor may, for example, re-orient the BFS products for packaging and/or shipping such as by causing the BFS products to lay flat and/or to be transported up an inclined slope to be deposited into one or more storage or shipping containers.

Although some of blocks 602-632 of method 600 have been described as being performed once, in some embodiments, multiple repetitions of a particular process block may be employed before proceeding to the next decision block or process block. In addition, although blocks 602-632 of method 600 have been separately illustrated and described, in some embodiments, process blocks may be combined and performed together (simultaneously or sequentially). For example, inspection of the neck of one BFS product in process block 618 may occur at the same time as inspection of the tab of another BFS product in process block 610 or 612. Moreover, although FIG. 6 illustrates a particular order for blocks 602-632, embodiments of the disclosed subject matter are not limited thereto. Indeed, in certain embodiments, the blocks may occur in a different order than illustrated or without other blocks. For example, in some embodiments, rejection by an upstream inspection process (e.g., any of 610, 612, 618, and 624) may cause the method to forgo one or more of the downstream inspection processes (e.g., any of 612, 618, 624, and 626) and to proceed directly to decision block 628, for example, by passing the intervening inspection stations or by conveying the BFS product through the intervening inspection stations without performing the corresponding inspection.

### IV. BFS Product Inspection Systems

An exemplary BFS product inspection system 200 will now be described in a manner that generally follows the path of any one or more BFS products 202 through the BFS product inspection system 200, in accordance with at least one embodiment of the BFS product inspection system 200. Variations in the path, order of processes and/or associated positioning of related inspection equipment and/or sensors are also possible according to one or more contemplated embodiments. In some embodiments, the BFS product inspection system 200 may be utilized to inspect various BFS products 202 such as the individual pre-filled BFS cards depicted in the figures. While these specific BFS products 202 are depicted for non-limiting exemplary purposes, other types, quantities, and/or configurations of BFS products 202 may be utilized in the BFS product inspection system 200 in accordance with some embodiments.

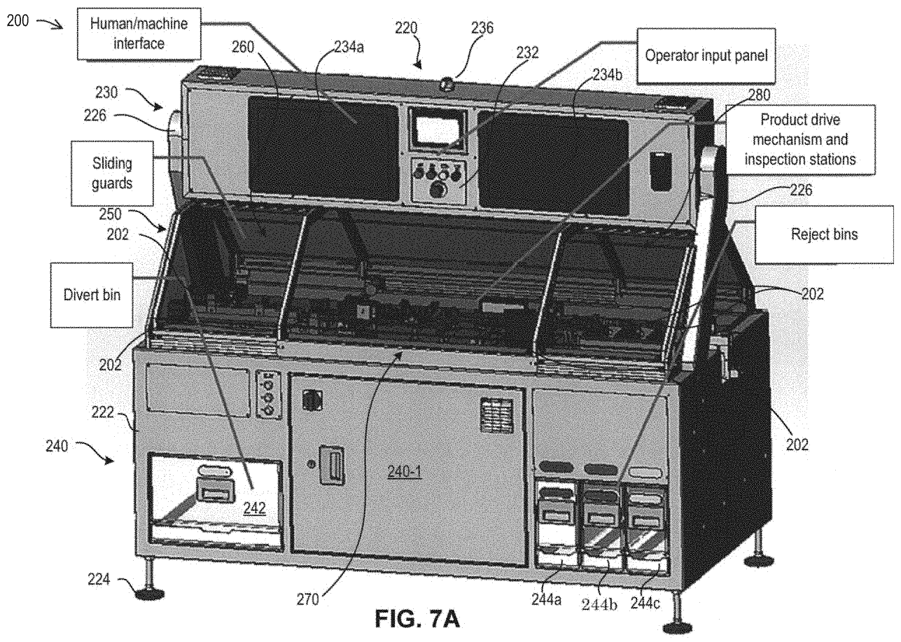

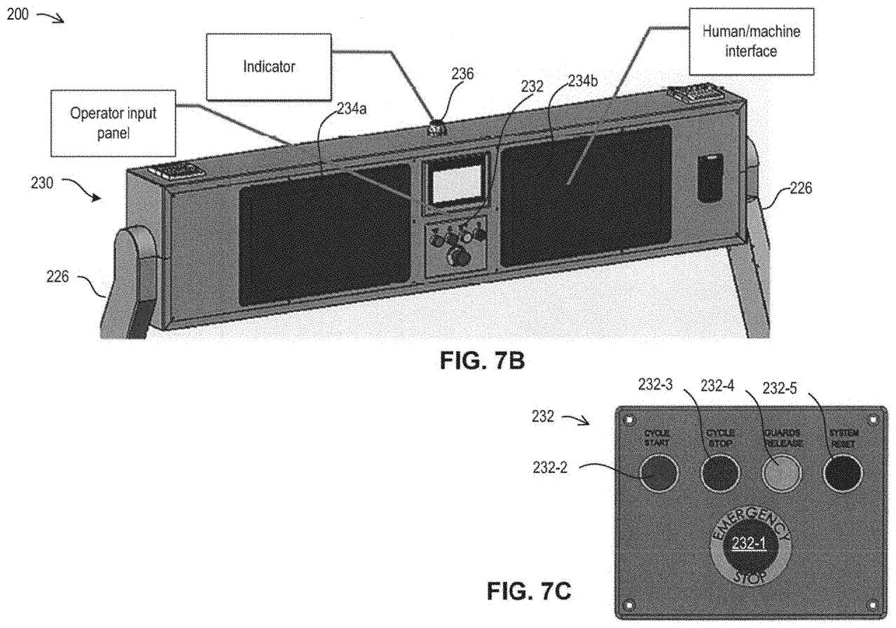

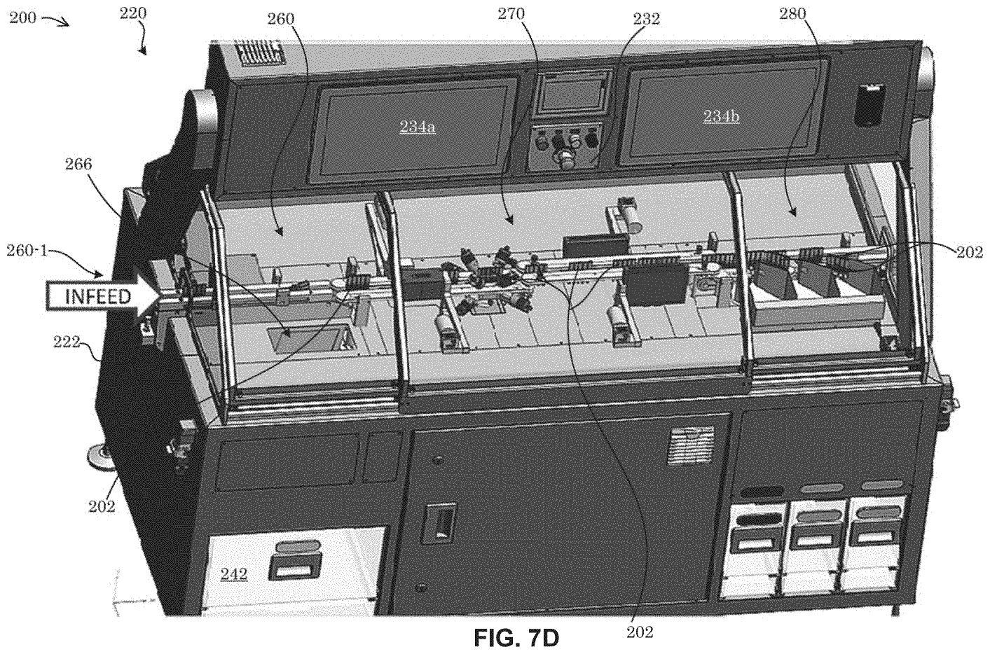

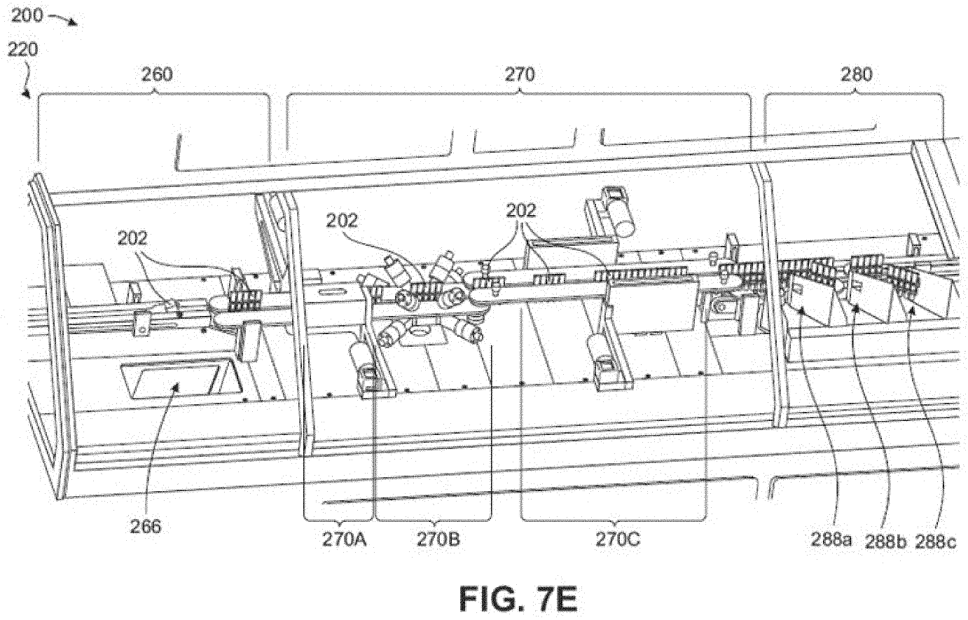

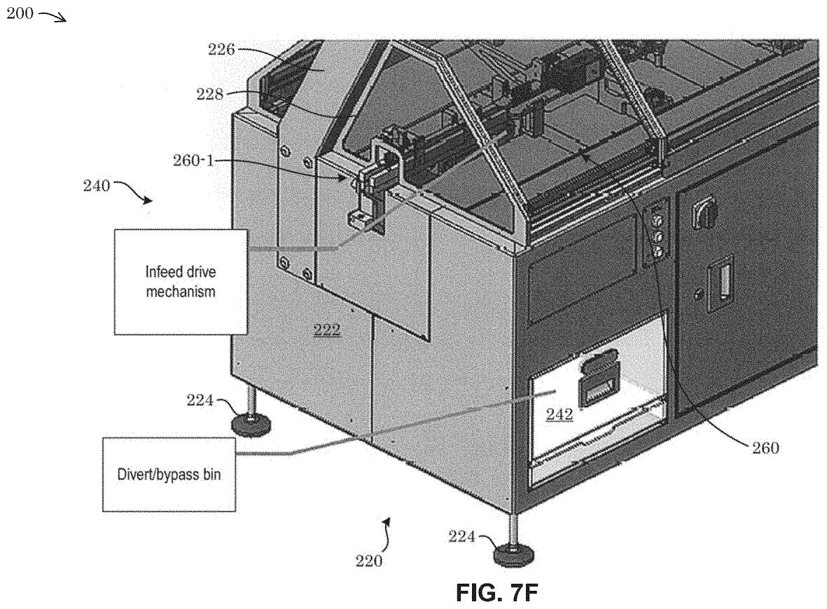

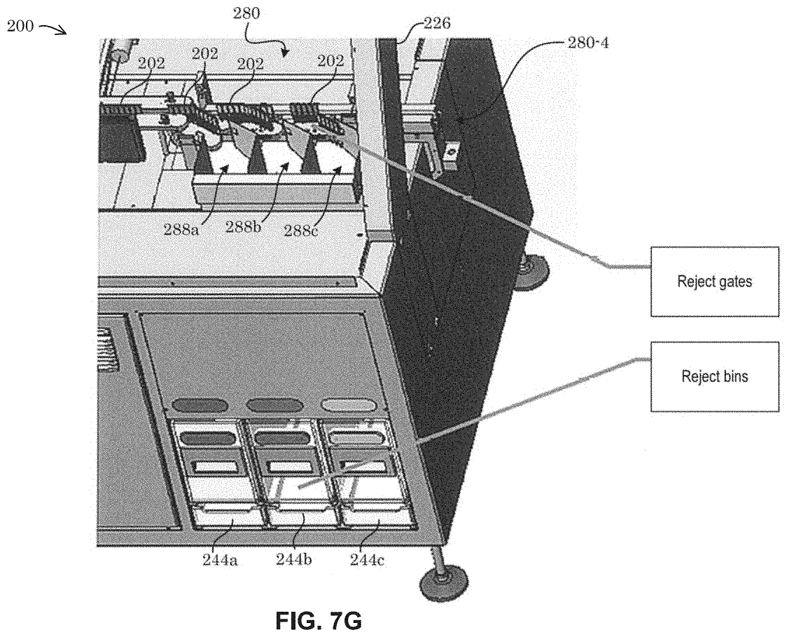

Referring to FIGS. 7A-7G, a BFS product inspection system 200 may comprise at least one BFS inspection machine 220 (see, e.g., FIG. 7A). The BFS inspection machine 220 may comprise, for example, a frame and/or housing 222 supported by one or more legs and/or feet 224 (e.g., adjustable for leveling, as depicted). In some embodiments, the BFS inspection machine 220 may comprise one or more supports 226 and/or one or more access guards and/or covers 228. In some embodiments, the supports 226 may couple to and/or support a control portion 230 of the BFS inspection machine 220. The control portion 230 (see, e.g., FIGS. 7A-7B) may comprise, for example, an operator control panel 232. The operator control panel 232 (see, e.g., FIGS. 7B-7C) may, in some embodiments, comprise a touch-sensitive input/output device and/or may comprise various “soft buttons” (e.g., Graphical Use Interface (GUI) elements), switches, knobs, physical buttons, dials, etc. The operator control panel 232 may comprise, for example, an emergency stop button 232-1, a cycle start button 232-2, a cycle stop button 232-3, a guard release button 232-4 (e.g., that releases or unlocks one or more of the covers 228), and/or a system reset button 232-5. In some embodiments, the operator control panel 232 may be housed in or by the control portion 230 along with one or more output devices 234a-b, 236.

In some embodiments, the control portion 230 may further comprise, for example, one or more displays 234a-b such as first and second Human-Machine Interface (HMI) displays. According to some embodiments, the displays 234a-b may output various visual information (e.g., data, images, graphs, warnings, etc.) regarding the operation of the BFS inspection machine 220 and/or regarding results of analyzing one or more of the BFS products 202. According to some embodiments, the control portion 230 may comprise an indicator device 236 (e.g., strobe light, single or multi-color indicator light, visual or audible alarm, speaker, any combination thereof, etc.). The indicator device 236 may, for example, be prominently positioned for optimal visibility by an operator (not shown).

In some embodiments, the housing 222 of the BFS inspection machine 220 may be coupled to and/or may retain a base portion 240. The base portion 240 may, for example, be disposed upon and/or supported by the feet 224 and/or may couple to and/or comprise or retain the supports 226. According to some embodiments, the base portion 240 may comprise and/or define an electrical access panel 240-1 (e.g., that controls access to the internal components of the BFS inspection machine 220 such as wires, cables, processing devices, controllers, circuit boards, breakers, relays, switches, etc. —none of which are shown), a bypass bin 242, and/or one or more reject bins 244a-c. As depicted (see, e.g., FIG. 2A), the various bins 242, 244a-c may be positioned for easy access by an operator and/or may be color-coded for easy identification of the nature of the BFS product 202 that has been deposited in respective bins 242, 244a-c.

According to some embodiments, the BFS inspection machine 220 may be coupled to and/or may retain or define an operations portion 250. The operations portion 250 may be disposed between the control portion 230 and the base portion 240, for example, and may be oriented and/or configured to align an infeed processing section 260 with upstream manufacturing elements (not shown—e.g., upstream devices and/or a manual feed device). For example, the BFS product 202 can initially be received at the infeed processing section 260, which can be configured to receive fabricated BFS products 202 directly from a BFS molding machine (e.g., conveyed from a demolding stage of BFS shuttling machine or a BFS rotary machine) or indirectly from a BFS molding machine (e.g., via a post-processing station, such as label creation station (e.g., laser-etching of and/or adhesive label fixing on tabs 126), punching station (e.g., to trim excess plastic), and/or card separation station (e.g., where a larger BFS product is separated into smaller constituent cards of multiple vials)).

The BFS product 202 can be conveyed from the infeed processing section 260 to inspection processing section 270 within the operations portions 250 for inspection and then to a routing (e.g., outfeed) section 280. In some embodiments, the inspection processing section 270 comprises and/or is defined by one or more stations (also referred to herein as sub-sections) arranged for sequential or parallel inspection of one or more physical attributes of the BFS product 202. For example, inspection processing section 270 can have a tab inspection station 270A, a neck inspection station 270B, and/or a body inspection station 270C.

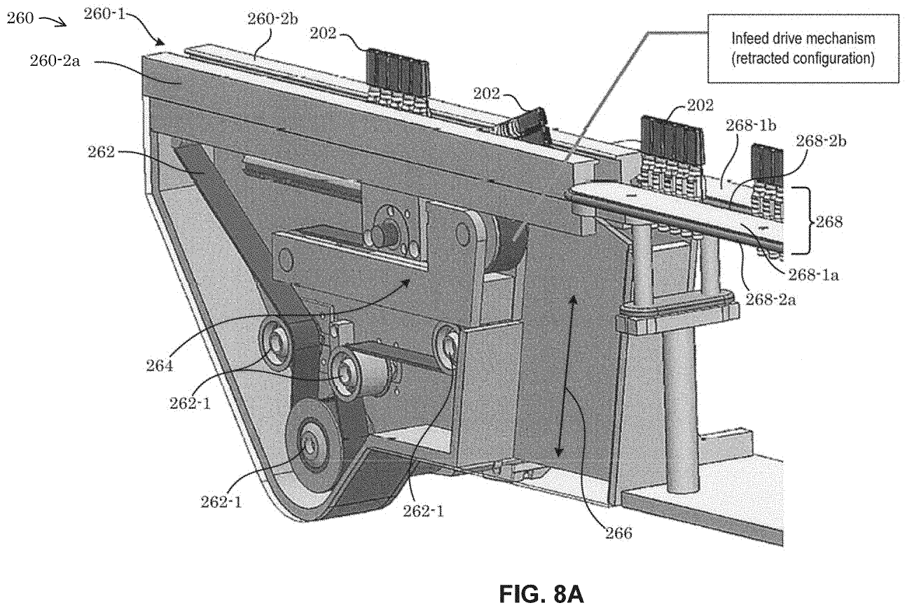

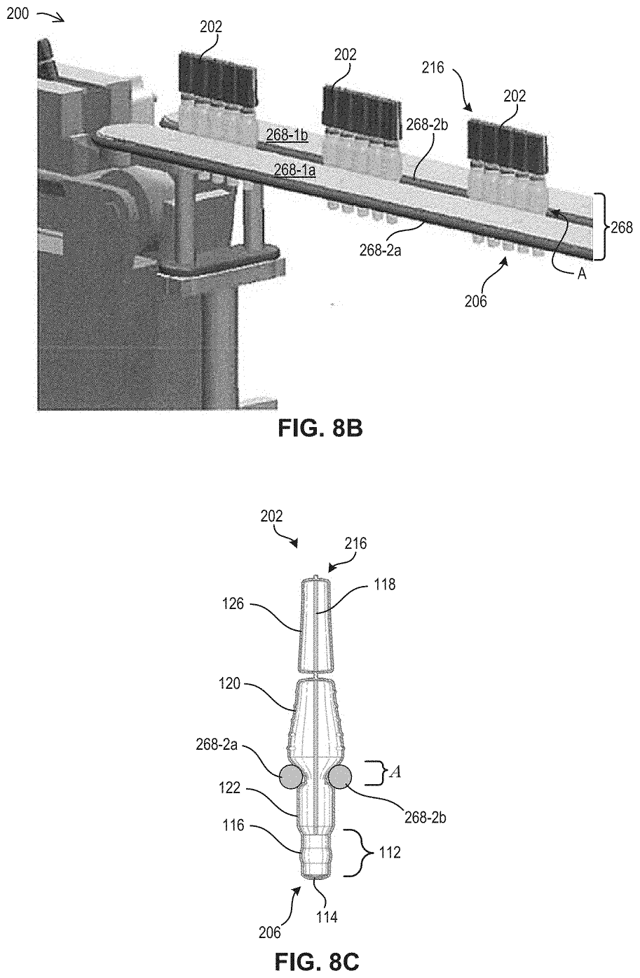

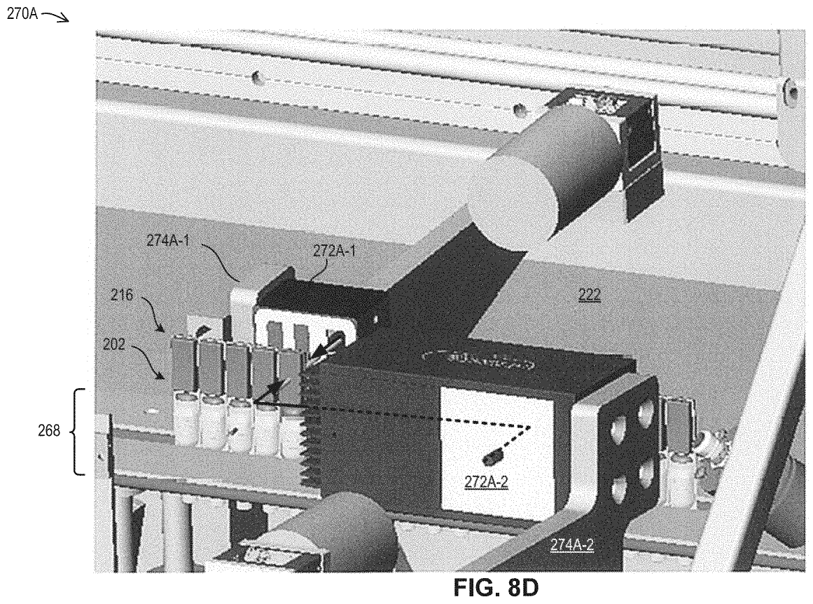

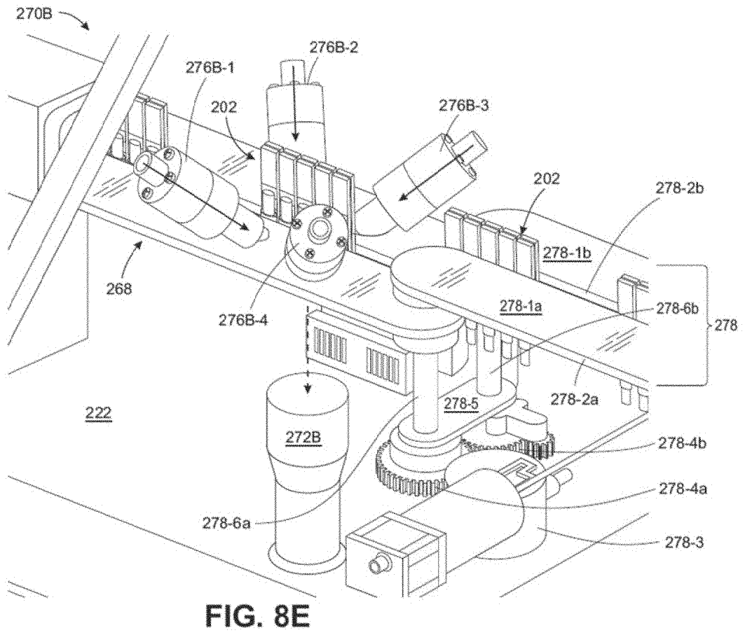

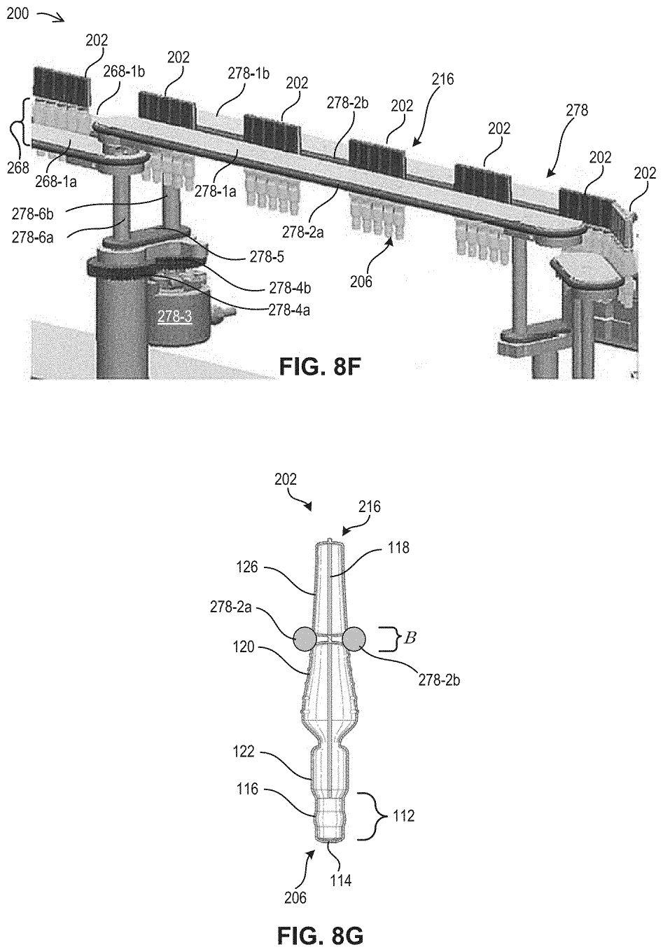

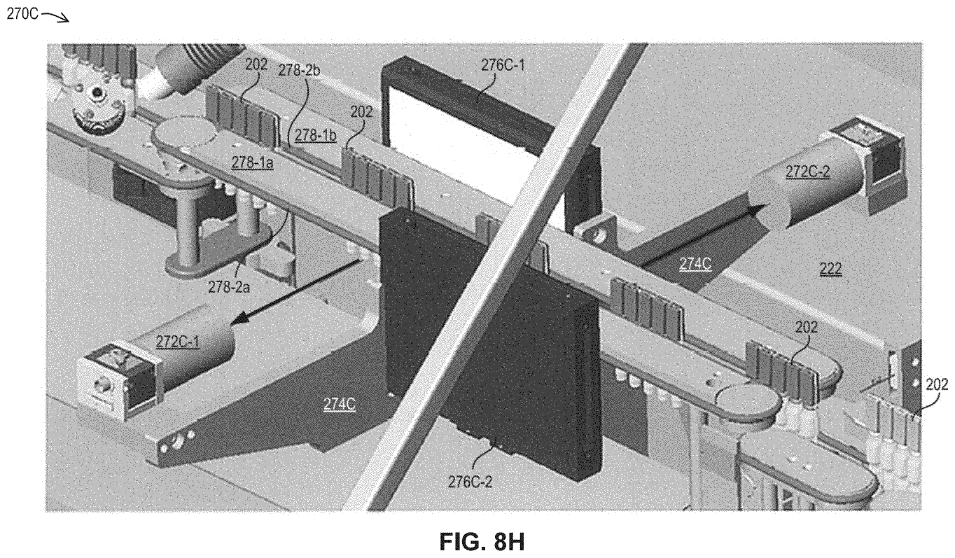

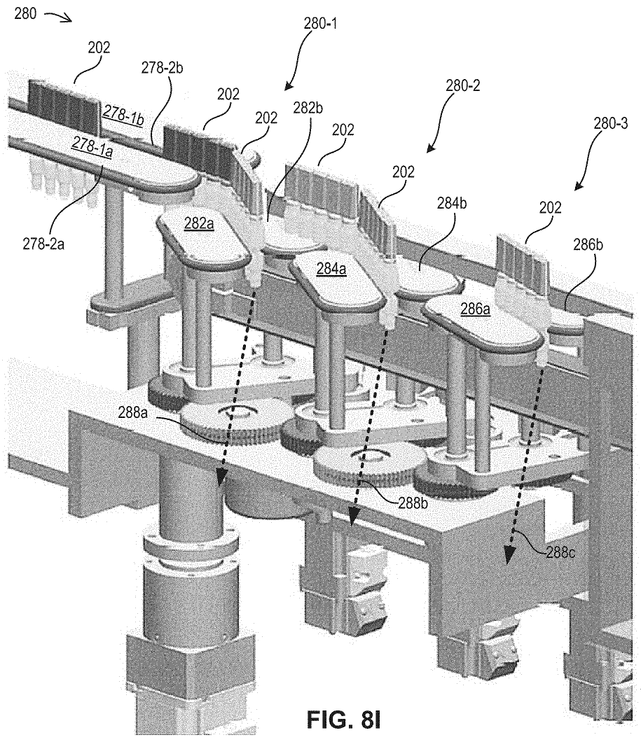

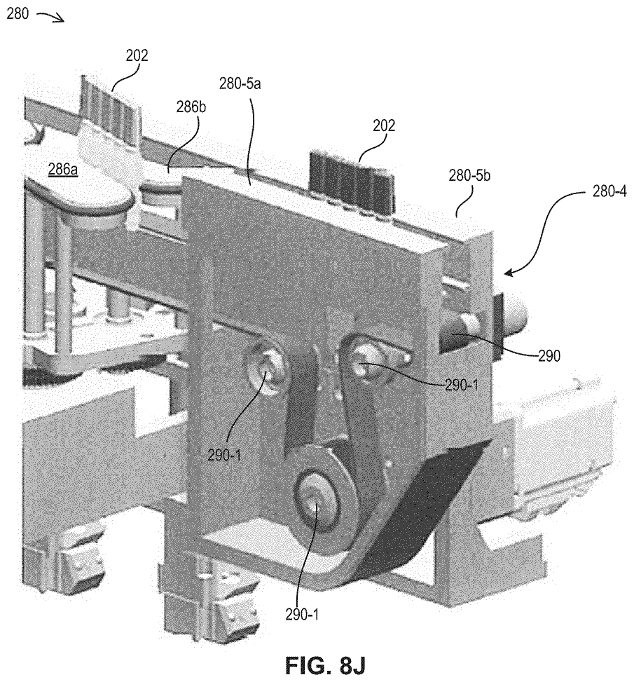

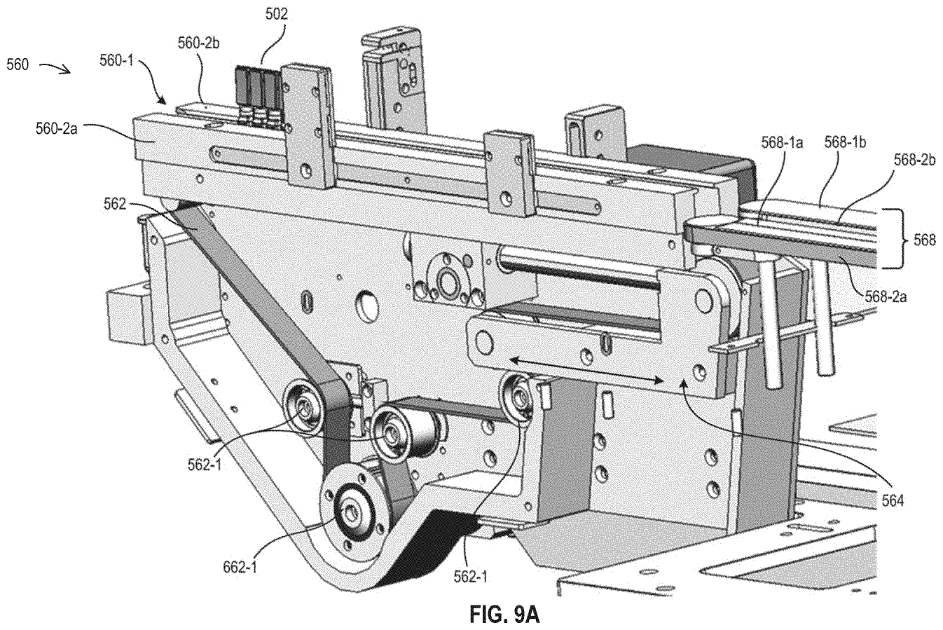

Referring to FIGS. 7F and 8A, the infeed processing section 260 may comprise and/or define an infeed port 260-1, via which the BFS product 202 is introduced into the BFS inspection machine 220. As depicted in FIG. 8A, the infeed processing section 260 may comprise one or more guide rails 260-2a, 260-2b into which the BFS product 202 is directed from the infeed port 260-1. According to some embodiments, the BFS product 202 may be moved along between the guide rails 260-2a, 260-2b by action of an infeed drive belt 262 that is routed through, supported and/or driven by one or more pulleys 262-1 (and/or by a motor (not shown)). In some embodiments, the fluid seals 114 of the BFS product 202 can rest upon an upper surface of the drive belt 262. Friction between the seals 114 and the drive belt 262 causes the BFS product 202 to move laterally with the belt 262, while the guide rails 260-2a, 260-2b maintain the BFS product 202 in a substantially upright orientation.

In some embodiments, the infeed processing section 260 may comprise an infeed belt retraction mechanism 264 that is operable to selectively redirect the infeed drive belt 262 to divert incoming BFS product 202. The infeed belt retraction mechanism 264 may, for example, pivot the plane of the infeed drive belt 262 such that one or more incoming BFS products 202 are directed through a bypass chute 266 and into the bypass bin 242. In some embodiments, the infeed belt retraction mechanism 264 may be utilized to prevent BFS products 202 from progressing into the inspection processing section 270 of the operations portion 250 of the BFS inspection machine 220 such as in the case of inspection processing failures and/or slow the rate of incoming BFS products 202. The BFS products 202 may be spaced at a desired spacing, for example, such as by controlling the speed of the infeed drive belt 262, operating the infeed belt retraction mechanism 264, and/or controlling the speed of the inspection processing section 270.

In some embodiments, any BFS products 202 not directed through the bypass chute 266 may be passed from the guide rails 260-2a, 260-2b and by the infeed drive belt 262 to a cooperating (first) planar drive 268, as shown in FIGS. 8A-8B. The planar drive 268 may comprise, for example, a frontal planar drive platform 268-1a disposed in a (first) plane and spaced from a rear planar drive platform 268-1b disposed in the same plane (e.g., a horizontal plane). In the illustrated example of FIGS. 8A-8B, the planar drive 268 comprises respective drive bands 268-2a, 268-2b (e.g., O-rings, belts, etc.) wrapped and/or seated around a periphery of the respective frontal and rear planar drive platforms 268-1a, 268-1b. In such a manner, for example, the drive bands 268-2a, 268-2b may engage with a BFS product 202 to retain the BFS product 202 in a particular orientation (e.g., substantially vertical orientation, with necks 112 and tabs 126 substantially exposed, as shown in FIGS. 8B-8E).

In some embodiments, and as shown in FIGS. 8B-8C, the drive bands 268-2a, 268-2b may be configured (e.g., sized and/or spaced) to seat in and/or engage with the first junction “A” of the BFS product 202. For example, each drive band can have a substantially circular shape in cross-section. In such a manner, the BFS product 202 may be maintained and driven in a vertical orientation (e.g., with longitudinal and/or axial direction substantially aligned with gravity), for example, with the tabs 126 at second end 216 pointed upwards and with the fluid seals 114 (and necks 112) at first end 206 facing downward. According to some embodiments, the BFS product 202 may be driven by the planar drive 268 from the infeed processing section 260 and into an inspection processing section 270 of the operations portion 250 of the BFS inspection machine 220.

As shown in FIG. 8D, in some embodiments, the planar drive 268 may move a BFS product 202 into the tab inspection station 270A, such that it passes a first tab imaging device 272A-1 and/or a second tab imaging device 272A-2. As depicted in FIG. 8D, for example, the first tab imaging device 272A-1 may be mounted to the housing 222 via a first tab imaging bracket 274A-1 such that it is oriented to capture images (and/or other data) from a first side (e.g., the back side, as shown) of the tabs 126 and/or the second tab imaging device 272A-2 may be mounted to the housing 222 via a second tab imaging bracket 274A-2 such that it is oriented to capture images (and/or other data) from a second side (e.g., the front side, as shown) of the tabs 126. In some embodiments, the tab imaging devices 272A-1, 272A-2 may comprise any type, quantity, and/or configuration of sensor devices that are or become known or practicable. In the case that the BFS inspection machine 220 is utilized to detect and/or analyze indicia (not shown) on or of the tabs 126, for example, the tab imaging devices 272A-1, 272A-2 may comprise one or more cameras, thermal imaging devices, radio frequency (and/or other signal) interrogators, laser scanning devices, magnetic field detectors and/or interrogators, etc. In some embodiments, the tab imaging devices 272A-1, 272A-2 and/or the tab inspection sub-section 270A may comprise one or more lighting elements configured to light the tabs 126 in coordination with capturing of data by the tab imaging devices 272A-1, 272A-2. In some embodiments, the lighting (and/or the imaging) may be oriented transverse to the orientation of the BFS product 202, e.g., to illuminate and image each respective side of the tabs 126. In some embodiments, the lighting elements may comprise strobe light devices that are coordinated to activate with the capturing of images/data by the tab imaging devices 272A-1, 272A-2.

According to some embodiments, any or all indicia from either or both sides of the tabs 126 may be sensed and/or analyzed by the BFS inspection machine 220 as part of the tab inspection sub-section 270A of the inspection processing section 270. The indicia may be compared to store data to ensure that the BFS product 202 identifiers (e.g., batch number, manufacturing information, fluid agent identifier and/or amount/dosage) match stored values. According to some embodiments, the operator may utilize the control portion 230 to input a desired indicia value to which the data sensed from the tabs 126 can be compared and/or matched. In some embodiments, in the case that any data (or any amount of and/or type of data exceeding a stored threshold) does not match, the BFS product 202 may be rejected and/or flagged with a failure indication and/or status.

As shown in FIG. 8E, in some embodiments, the planar drive 268 may move the BFS product 202 into the neck inspection sub-section 270B, such that it passes over a neck imaging device 272B. As depicted in FIG. 8E, for example, the neck imaging device 272B may be mounted to the housing 222 vertically such that it is oriented to capture axial images (and/or other data) of the seals 114 (and/or the necks 112) at the first end 206 of the BFS product 202. In some embodiments, the neck imaging device 272B may comprise any type, quantity, and/or configuration of sensor device that is or becomes known or practicable. According to some embodiments, the neck inspection sub-section 270B may comprise one or more lighting devices 276B-1, 276B-2, 276B-3, 276B-4 oriented to direct light onto the BFS product 202. In some embodiments, the lighting devices 276B-1, 276B-2, 276B-3, 276B-4 may be angled to direct light at and/or around the necks 112 of the BFS product 202.

As noted above, due to the nature of the translucent plastic forming the BFS product 202, for example, angled lighting may permit the neck imaging device 272B to capture images that have a resolution conducive to image analysis processing, for example, in order to characterize the compliance of the coupling portion 116 with predetermined criteria. In contrast, axial lighting may significantly reduce the image quality such that the resolution is not conducive to image analysis processing. Thus, in some embodiments, the lighting devices 276B-1, 276B-2, 276B-3, 276B-4 may comprise one or more light tubes and/or fiber optic pathways that are oriented to direct light to specific portions of the necks 112 (e.g., coupling portion 116) of the BFS product 202 and/or at specific angles with respect to the orientation of the neck imaging device 272B. As depicted in FIG. 8E, four (4) lighting devices 276B-1, 276B-2, 276B-3, 276B-4 may be utilized and may be distributed to direct light around the circumference of the necks 112 of the BFS product 202, for example, at or around a perimeter of the coupling portion 116, or at other portions of the neck 112 proximal to the coupling portion 116. According to some embodiments, fewer or more lighting devices 276B-1, 276B-2, 276B-3, 276B-4 may be utilized.

In some embodiments, the imagery/data captured by the neck imaging device 272B may be analyzed to identify and/or quantify various characteristics of the necks 112 of the BFS product 202. The neck inspection sub-section 270B may analyze, for example, (i) the shape and/or dimensions of the coupling portions 116, (ii) the shape and/or dimensions of other portions of the necks 112, and/or (iii) the shape and/or dimensions of the seals 114. According to some embodiments, in the case that any data (or any amount of and/or type of data exceeding a stored threshold) does not fall within acceptable thresholds, the BFS product 202 may be rejected and/or flagged with a failure indication and/or status.

As shown in FIGS. 8E-8G, in some embodiments, a second planar drive 278 may be utilized to reposition the support of the BFS product 202. For example, the second planar drive 278 may comprise a second frontal planar drive platform 278-1a disposed in a second plane and spaced from a second rear planar drive platform 278-1b disposed in the same second plane (e.g., a horizontal plane). As shown in FIGS. 8E-8F, the second plane may be disposed and/or offset higher than the first plane of the first planar drive 268 and/or the second planar drive 278 may comprise respective second drive bands 278-2a, 278-2b (e.g., O-rings, belts, etc.) wrapped and/or seated around a periphery of the respective second frontal and second rear planar drive platforms 278-1a, 278-1b.

As discussed above, the first planar drive 268 may engage and/or support the BFS product 202 at or via the first junction “A”, which may expose the tabs 126 and the necks 112, seals 114, and coupling portions 116 for inspection. However, this support configuration may obscure or cover other portions of the BFS product 202, such as all or part of reservoirs 120, 122. Accordingly, in some embodiments, the second planar drive 278 can be used to expose the reservoirs for subsequent inspection, for example, by engaging and/or supporting the BFS product 202 at or via the second junction “B.” In some embodiments, and as shown in FIGS. 8E-8F, the drive bands 278-2a, 278-2b may be configured (e.g., sized and/or spaced) to seat in and/or engage with the second junction “B” of the BFS product 202. For example, each drive band can have a substantially circular shape in cross-section. In such a manner, the BFS product 202 may be supported and driven in a vertical orientation (e.g., with longitudinal and/or axial direction substantially aligned with gravity), for example, with the tabs 126 at second end 216 pointed upwards and with the fluid seals 114 (and necks 112) at first end 206 facing downward. According to some embodiments, the BFS product 202 may be driven by the second planar drive 278 from a handover region at the end of the first planar drive 268 (e.g., after the neck inspection station 270B) into the body inspection station 270C, as shown in FIGS. 8F and 8H.

In some embodiments, a planar drive motor 278-3 may be mounted to engage with (e.g., impart rotation to) two (2) planar drive gears 278-4a, 278-4b. According to some embodiments, a dual-drive bracket 278-5 may be coupled to retain and/or house two (2) planar drive shafts 278-6a, 278-6b, one for each cooperative second frontal and second rear planar drive platforms 278-1a, 278-1b. In some embodiments, the planar drive shafts 278-6a, 278-6b and/or the planar drive gears 278-4a, 278-4b may be coupled to drive either or both of the second drive bands 278-2a, 278-2b of the second planar drive 278 and the first drive bands 268-2a, 268-2b of the first planar drive 268. In such a manner, for example, the drive bands 268-2a, 268-2b, 278-2a, 278-2b may all be maintained at the same velocity, e.g., to ensure steady and smooth movement of the BFS product 202 through the inspection processing section 270.

As shown in FIG. 8H, in some embodiments, the second planar drive 278 may move the BFS product 202 through the body inspection station 270C, such that it passes a first body imaging device 2720-1 and/or a second body imaging device 272C-2. As depicted in FIG. 8H, for example, the first body imaging device 2720-1 may be mounted to the housing 222 via a body imaging bracket 274C such that it is oriented to capture images (and/or other data) from a first side (e.g., the front side, as shown) of the BFS product 202 and/or the second body imaging device 272C-2 may be mounted to the housing 222 via the body imaging bracket 274C such that it is oriented to capture images (and/or other data) from a second side (e.g., the back side, as shown) of the BFS product 202. In some embodiments, the body imaging devices 272C-1, 272C-2 may comprise any type, quantity, and/or configuration of sensor devices that are or become known or practicable. According to some embodiments, the body inspection station 270C may comprise one or more lighting devices 2760-1, 276C-2 oriented to direct light onto and/or through the BFS product 202. In some embodiments, the lighting devices 276C-1, 276C-2 may be oriented opposite of their respective body imaging devices 272C-1, 272C-2 such as to provide good contrast for the captured images.

In some embodiments, the imagery/data captured by the body imaging devices 2720-1, 272C-2 may be analyzed to identify and/or quantify various characteristics of the BFS product 202. The body inspection station 270C may analyze, for example, (i) the shape and/or dimensions of the fluid reservoirs 122, (ii) the shape and/or dimensions of the shoulders 119, (iii) the shape and/or dimensions of the compressible reservoirs 120, (iv) whether any particles are embedded in the plastic walls of the BFS product 202, (v) the opacity of the walls of the BFS product 202, (vi) whether any portions of the BFS product 202 are deformed, (vii) whether the edges of the BFS product 202 are properly punched/trimmed, (viii) whether the BFS product 202 comprises any excess plastic, and/or (ix) whether liquid is present in the BFS product 202 (e.g., in the fluid reservoir 122 and/or neck 112). According to some embodiments, in the case that any data (or any amount of and/or type of data exceeding a stored threshold) does not fall within acceptable thresholds, the BFS product 202 may be rejected and/or flagged with a failure indication and/or status.

In some embodiments, the BFS product 202 may be driven by the second planar drive 278 from the inspection processing section 270 and into output processing section 280 (also referred to herein as rejection processing section) of the operations portion 250 of the BFS inspection machine 220. In some embodiments, and shown in FIGS. 7G and 8I, the rejection processing section 280 may comprise a plurality rejection stations or sub-sections 280-1, 280-2, 280-3 and/or an outfeed section 280-4. Each rejection sub-section 280-1, 280-2, 280-3 may comprise, in some embodiments, a rejection drive 282a-b, 284a-b, 286a-b and a corresponding rejection passage, gate, or chute 288a-c, e.g., that is oriented and/or disposed to direct rejected BFS products 202 into respective reject bins 244a-c (see, e.g., FIG. 7G). The rejection processing section 280 may, for example, selectively actuate or activate one or more of the rejection drives 282a-b, 284a-b, 286a-b to direct a particular BFS product 202 into an appropriate rejection bin 244a-c.

As shown in FIG. 8I, the rejection drives 282a-b, 284a-b, 286a-b may each comprise a frontal planar drive 282a, 284a, 286a and a cooperative rear planar drive 282b, 284b, 286b. In some embodiments, the rejection drives 282a-b, 284a-b, 286a-b may be individually and/or collectively reoriented such as via the pivoting mechanisms shown (but not separately labeled) that permit travelling BFS product 202 to be diverted from the linear path defined between the infeed 260-1 and the outfeed 280-4. In some embodiments, each rejection drive and respective rejection bin may correspond to one of the inspection stations 270A-C (e.g., with rejections indicated by tab inspection station 270A being routed to bin 244a, rejections indicated by neck inspection station 270B being routed to bin 244b, etc.).

As shown in FIG. 8J, in some embodiments, any BFS product 202 that has not been tagged or flagged with a failure indication and/or status may be moved through an outfeed port 280-4, for example, to process the BFS product 202 for subsequent storage (e.g., packaging), transport, and/or use. In some embodiments, an outfeed drive mechanism can comprise and/or be defined by an outfeed drive belt and a pair of guide rails 280-5a, 280-5b. The BFS product 202 may be moved along between the guide rails 280-5a, 280-5b by action of an outfeed drive belt 290 that is routed through, supported and/or driven by one or more pulleys 290-1 (and/or by a motor; not shown), for example, in a manner similar to that employed by the infeed processing section 260.

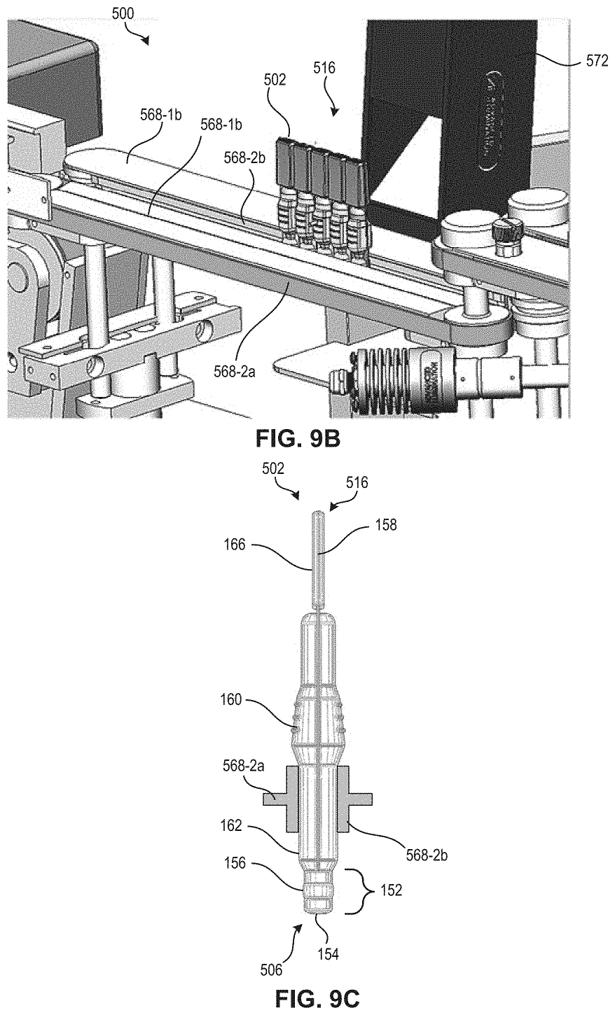

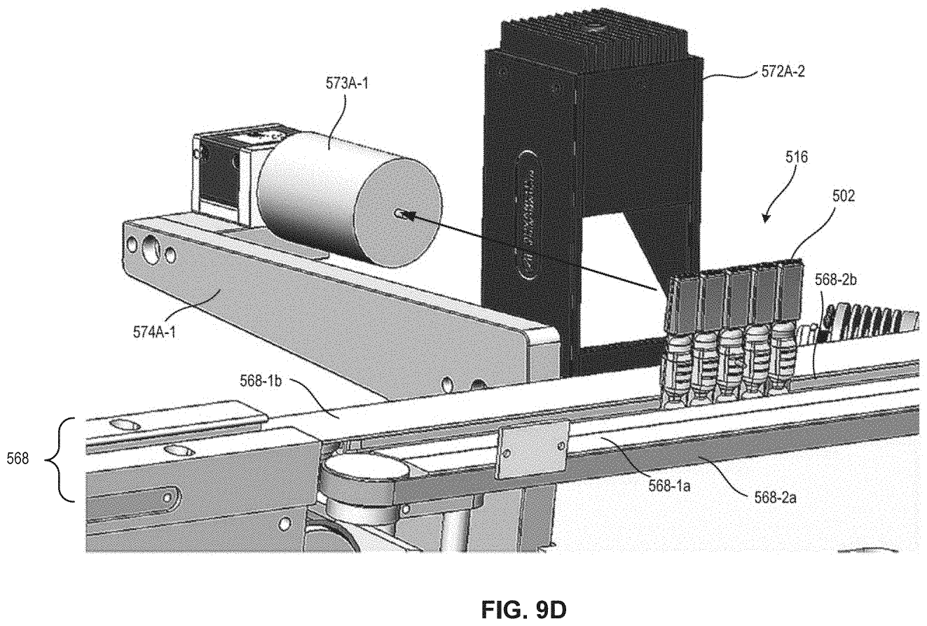

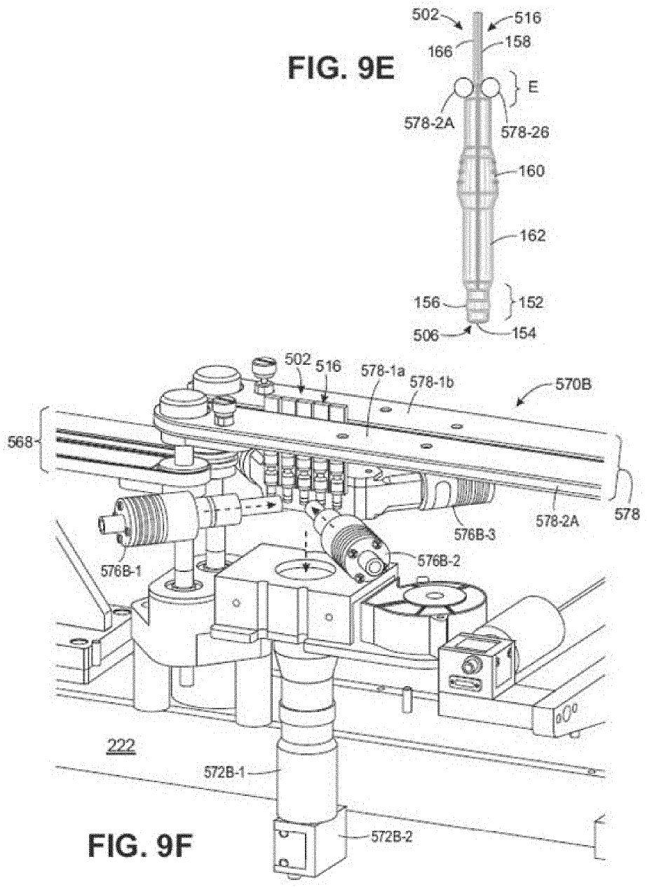

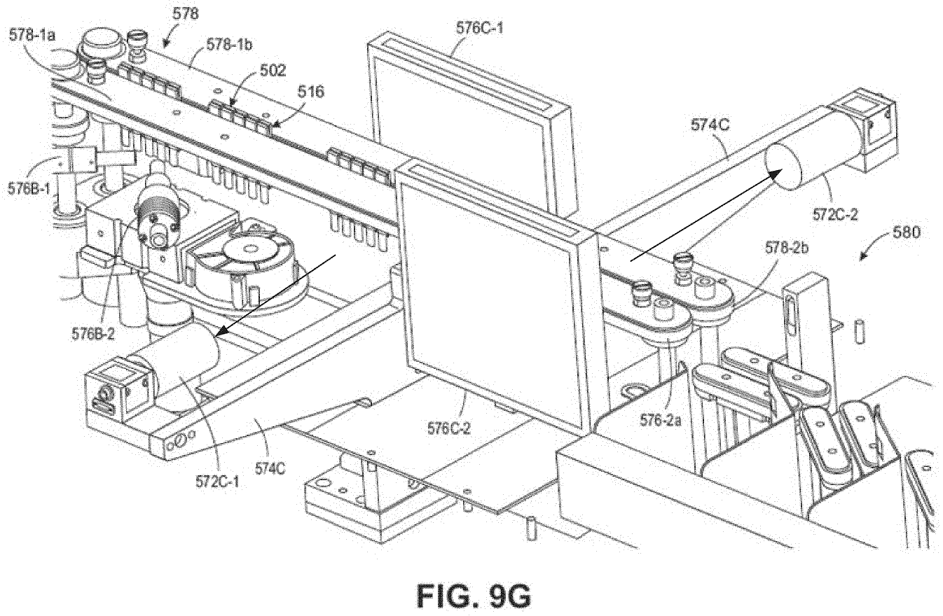

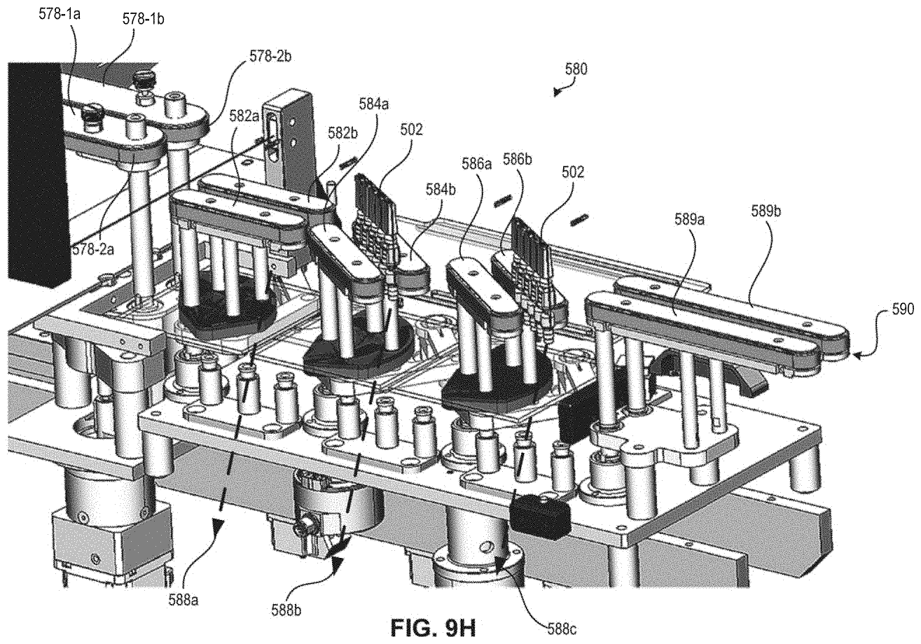

Referring to FIGS. 9A-9H, alternative configurations for operations portion 250 of BFS inspection machine 220 are shown, for example, for use in inspecting a BFS product 502 formed of a plurality of BFS vials 150 that lack a constriction between reservoirs. In some embodiments, the BFS product 502 can be conveyed from infeed processing section 560 to inspection processing section within the operations portion for inspection and then to a routing (e.g., outfeed) section 580. As with the above describe example, the inspection processing section can comprise and/or be defined by one or more stations, such as tab inspection station 570A, a neck inspection station 570B, and/or a body inspection station 570C.

Referring to FIG. 9A, the infeed processing section 560 may comprise and/or define an infeed port 560-1, via which the BFS product 502 is introduced into the BFS inspection machine. As depicted in FIG. 9A, the infeed processing section 560 can comprise an infeed drive belt 562 that moves the BFS product 502 laterally between the one or more guide rails 560-2a, 560-2b from the infeed port 560-1 to the inspection processing section. According to some embodiments, the infeed drive belt 562 can be routed through, supported and/or driven by one or more pulleys 562-1 (and/or by a motor (not shown)). In some embodiments, the infeed processing section 560 can comprise an infeed belt retraction mechanism 564 that is operable to selectively redirect the infeed drive belt 562 to divert incoming BFS product 202. The infeed belt retraction mechanism 564 may, for example, pivot the plane of the infeed drive belt 562 such that one or more incoming BFS products 502 are directed through a bypass chute 566 (shown in the closed configuration in FIG. 9A). The infeed processing section 560 may otherwise operate in a manner similar to that described above for infeed processing section 260 of FIG. 8A.

In some embodiments, any BFS products 502 not directed through the bypass chute 566 may be passed from the guide rails 560-2a, 560-2b and by the infeed drive belt 562 to a cooperating planar drive 568, as shown in FIGS. 9A-9B, which can comprise a frontal planar drive platform 568-1a disposed in a (first) plane and spaced from a rear planar drive platform 568-1b disposed in the same plane (e.g., a horizontal plane). As shown in FIGS. 9A-9B, the planar drive 568 can comprise respective drive bands 568-2a, 568-2b (e.g., O-rings, belts, etc.) wrapped and/or seated around a periphery of the respective frontal and rear planar drive platforms 568-1a, 568-1b. In such a manner, for example, the drive bands 568-2a, 568-2b may engage with a BFS product 502 to retain the BFS product 502 in a particular orientation (e.g., substantially vertical orientation, with necks 152 and tabs 166 substantially exposed, as shown in FIGS. 9B-9C).

As noted above, BFS product 502 may lack constrictions between reservoirs 160, 162 that the planar drive 568 may otherwise have used for engagement. Accordingly, in some embodiments, and as shown in FIGS. 9B-9C, the drive bands 568-2a, 568-2b may be configured (e.g., sized and/or spaced) to grip and/or engage with opposite surfaces of the reservoirs 162 (e.g., front and back surfaces) or portions thereof. For example, each drive band can have a T-shape in cross-section, as shown in FIG. 9C. In such a manner, the BFS product 502 may be maintained and driven in a vertical orientation (e.g., with longitudinal and/or axial direction substantially aligned with gravity), for example, with the tabs 166 at second end 516 pointed upwards and with the fluid seals 154 (and necks 152) at first end 506 facing downward. According to some embodiments, the BFS product 502 may be driven by the planar drive 568 from the infeed processing section 560 and into an inspection processing section 570 of the operations portion 250 of the BFS inspection machine 220.

As shown in FIG. 9D, in some embodiments, the planar drive 568 may move a BFS product 502 into the tab inspection station 570A, such that it passes a first tab imaging device 573A-1 and/or a second tab imaging device (not shown but can be disposed on an opposite of the planar drive from optical component 572A-2 (e.g., an illumination source or a detector). As depicted in FIG. 9D, for example, the first tab imaging device 573A-1 may be mounted to the housing via a first tab imaging bracket 574A-1 such that it is oriented to capture images (and/or other data) from a first side (e.g., the back side, as shown) of the tabs 166. The second tab imaging device may be mounted in a similar manner on an opposite side of the planar drive 568, for example, such that it is oriented to capture images (and/or other data) from a second side (e.g., the front side, as shown) of the tabs 166.

In some embodiments, the first and second tab imaging devices may comprise any type, quantity, and/or configuration of sensor devices that are or become known or practicable. In the case that the BFS inspection machine is utilized to detect and/or analyze indicia (not shown) on or of the tabs 166, for example, the tab imaging devices may comprise one or more cameras, thermal imaging devices, radio frequency (and/or other signal) interrogators, laser scanning devices, magnetic field detectors and/or interrogators, etc. In some embodiments, the tab imaging devices and/or the tab inspection sub-section 570A may comprise one or more lighting elements configured to light the tabs 166 in coordination with capturing of data by the tab imaging devices. In some embodiments, the lighting (and/or the imaging) may be oriented transverse to the orientation of the BFS product 502, e.g., to illuminate and image each respective side of the tabs 166. In some embodiments, the lighting elements may comprise strobe light devices that are coordinated to activate with the capturing of images/data by the tab imaging devices.

As shown in FIGS. 9E-9F, in some embodiments, a second planar drive 578 may be utilized to reposition the support of the BFS product 502. For example, the second planar drive 578 may comprise a second frontal planar drive platform 578-1a disposed in a second plane and spaced from a second rear planar drive platform 578-1b disposed in the same second plane (e.g., a horizontal plane). As shown in FIGS. 9E-9F, the second plane may be disposed and/or offset higher than the first plane of the first planar drive 568, and/or the second planar drive 578 may comprise respective second drive bands 578-2a, 578-2b (e.g., O-rings, belts, etc.) wrapped and/or seated around a periphery of the respective second frontal and second rear planar drive platforms 578-1a, 578-1b.

As discussed above, the first planar drive 568 may grip and/or support the BFS product 502 at opposite surfaces of reservoirs 162, which may expose the tabs 166 and the necks 152, seals 154, and coupling portions 156 for inspection. However, this support configuration may obscure or cover other portions of the BFS product 502, such as all or part of reservoirs 520, 522. Accordingly, in some embodiments, the second planar drive 578 can be used to expose the reservoirs and/or further expose the necks 152 for subsequent inspection, for example, by engaging and/or supporting the BFS product 502 at or via the second junction “E.” In some embodiments, and as shown in FIGS. 9E-9F, the drive bands 578-2a, 578-2b may be configured (e.g., sized and/or spaced) to seat in and/or engage with the second junction “E” of the BFS product 502. For example, each drive band can have a substantially circular shape in cross-section. In such a manner, the BFS product 502 may be supported and driven in a vertical orientation (e.g., with longitudinal and/or axial direction substantially aligned with gravity), for example, with the tabs 166 at second end 516 pointed upwards and with the fluid seals 154 (and necks 152) at first end 506 facing downward. According to some embodiments, the BFS product 502 may be driven by the second planar drive 578 from a handover region at the end of the first planar drive 568 (e.g., after the tab inspection station 270A) into the neck inspection station 270B, as shown in FIGS. 9D and 9F.

As shown in FIG. 9F, in some embodiments, the second planar drive 568 may move the BFS product 502 into the neck inspection sub-section 570B, such that it passes over a neck imaging device. For example, in some embodiments, the neck imaging device can comprise an imaging device 572B-2 coupled to collection optics 572B-1, which together can form a detection assembly with input optical axis parallel to (e.g., collinear with) a longitudinal direction of one of the vials of BFS product 502 being inspected (e.g., disposed as a target position). As depicted in FIG. 9E, for example, the neck imaging device may be mounted vertically such that it is oriented to capture axial images (and/or other data) of the seals 154 (and/or the necks 152) at the first end 506 of the BFS product 502. In some embodiments, the neck imaging device may comprise any type, quantity, and/or configuration of sensor device that is or becomes known or practicable.

According to some embodiments, the neck inspection sub-section 570B may comprise one or more lighting devices 576B-1, 576B-2, 576B-3, 576B-4 oriented to direct light onto the BFS product 502. In some embodiments, the lighting devices 576B-1, 576B-2, 576B-3, 576B-4 may be angled to direct light at and/or around the necks 152 of the BFS product 502. In some embodiments, the lighting devices 576B-1, 576B-2, 576B-3, 576B-4 may comprise one or more light tubes and/or fiber optic pathways that are oriented to direct light to specific portions of the necks 152 (e.g., coupling portion 156) of the BFS product 502 and/or at specific angles with respect to the orientation of the neck imaging device. As depicted in FIG. 9E, four (4) lighting devices 576B-1, 576B-2, 576B-3, 576B-4 may be utilized and may be distributed to direct light around the circumference of the necks 152 of the BFS product 502, for example, at or around a perimeter of the coupling portion 154, or at other portions of the neck 152 proximal to the coupling portion 154. According to some embodiments, fewer or more lighting devices 576B-1, 576B-2, 576B-3, 576B-4 may be utilized.

In some embodiments, the imagery/data captured by the neck imaging device of inspection station 570B may be analyzed to identify and/or quantify various characteristics of the necks 152 of the BFS product 502. The neck inspection station 570B may analyze, for example, (i) the shape and/or dimensions of the coupling portions 156, (ii) the shape and/or dimensions of other portions of the necks 152, and/or (iii) the shape and/or dimensions of the seals 154. According to some embodiments, in the case that any data (or any amount of and/or type of data exceeding a stored threshold) does not fall within acceptable thresholds, the BFS product 502 may be rejected and/or flagged with a failure indication and/or status.

As shown in FIG. 9G, in some embodiments, the second planar drive 578 may move the BFS product 502 from the neck inspection station 570B into and through the body inspection station 570C, such that it passes a first body imaging device 572C-1 and/or a second body imaging device 572C-2. As depicted in FIG. 9G, for example, the first body imaging device 572C-1 may be mounted to the housing 222 via a body imaging bracket 574C such that it is oriented to capture images (and/or other data) from a first side (e.g., the front side, as shown) of the BFS product 502 and/or the second body imaging device 572C-2 may be mounted to the housing 222 via the body imaging bracket 574C such that it is oriented to capture images (and/or other data) from a second side (e.g., the back side, as shown) of the BFS product 502. In some embodiments, the body imaging devices 572C-1, 572C-2 may comprise any type, quantity, and/or configuration of sensor devices that are or become known or practicable. According to some embodiments, the body inspection station 570C may comprise one or more lighting devices 5760-1, 576C-2 oriented to direct light onto and/or through the BFS product 502. In some embodiments, the lighting devices 576C-1, 576C-2 may be oriented opposite of their respective body imaging devices 5720-1, 572C-2 such as to provide good contrast for the captured images.

In some embodiments, the imagery/data captured by the body imaging devices 5720-1, 572C-2 may be analyzed to identify and/or quantify various characteristics of the BFS product 502. The body inspection station 570C may analyze, for example, (i) the shape and/or dimensions of the fluid reservoirs 162, (ii) the shape and/or dimensions of the shoulders 158, (iii) the shape and/or dimensions of the compressible reservoirs 160, (iv) whether any particles are embedded in the plastic walls of the BFS product 502, (v) the opacity of the walls of the BFS product 502, (vi) whether any portions of the BFS product 502 are deformed, (vii) whether the edges of the BFS product 502 are properly punched/trimmed, (viii) whether the BFS product 502 comprises any excess plastic, and/or (ix) whether liquid is present in the BFS product 502 (e.g., in the fluid reservoir 162 and/or neck 152). According to some embodiments, in the case that any data (or any amount of and/or type of data exceeding a stored threshold) does not fall within acceptable thresholds, the BFS product 502 may be rejected and/or flagged with a failure indication and/or status.

In some embodiments, the BFS product 502 may be driven by the second planar drive 578 from the inspection processing section 570 and into output processing section 580 (also referred to herein as rejection processing section) of the operations portion 250 of the BFS inspection machine 220. In some embodiments, and shown in FIG. 9H, the rejection processing section 580 may comprise a plurality rejection stations or sub-sections and/or an outfeed section. Each rejection station may comprise, in some embodiments, a rejection drive 582a-b, 584a-b, 586a-b, and a corresponding rejection passage, gate, or chute 588a-c, e.g., that is oriented and/or disposed to direct rejected BFS products 502 into respective reject bins 244a-c (see, e.g., FIG. 7G). The rejection processing section 580 may, for example, selectively actuate or activate one or more of the rejection drives 582a-b, 584a-b, 586a-b to direct a particular BFS product 502 into an appropriate rejection bin 544a-c, in a manner similar to that described above for rejections drives 282-286 in FIG. 8I.

As shown in FIG. 9H, the rejection drives 582a-b, 584a-b, 586a-b may each comprise a frontal planar drive 582a, 584a, 586a and a cooperative rear planar drive 582b, 584b, 586b. In some embodiments, each rejection drive can have a configuration similar to that of the first planar drive 568, for example, with respective drive bands configured (e.g., sized and/or shaped) to grip and/or engage with opposite surfaces of reservoirs 162. For example, each drive band can have a T-shape in cross-section. In some embodiments, the rejection drives 582a-b, 584a-b, 586a-b may be individually and/or collectively reoriented, such as via the pivoting mechanisms shown (but not separately labeled), to permit travelling BFS product 502 to be diverted from the linear path defined between the infeed 560-1 and the outfeed 590.

As shown in FIG. 9H, in some embodiments, any BFS product 502 that has not been tagged or flagged with a failure indication and/or status may be moved through an outfeed port 590, for example, to process the BFS product 502 for subsequent storage (e.g., packaging), transport, and/or use. In some embodiments, an outfeed drive mechanism can comprise and/or be defined a frontal planar drive 589a, and a cooperative rear planar drive 589b. In some embodiments, the outfeed drive can have a configuration similar to that of the first planar drive 568, for example, with respective drive bands configured (e.g., sized and/or shaped) to grip and/or engage with opposite surfaces of reservoirs 162. For example, each drive band can have a T-shape in cross-section.

In some embodiments, fewer or more components 220-280, 560-590 and/or various configurations of the depicted components 220-280, 560-590 may be included in the BFS product inspection system 200 without deviating from the scope of embodiments described herein. In some embodiments, the components 220-280, 560-590 may be similar in configuration and/or functionality to similarly named and/or numbered components as described herein.

### V. BFS Product Imaging and Analysis

Referring to FIGS. 10A-10B, exemplary images 300a-b of a BFS product 302 according to some embodiments are shown. In some embodiments, the image 300a can be captured by a neck inspection station of a BFS product inspection machine, and image 300b can be captured by a body inspection station of a BFS product inspection machine, for example, configured in a manner similar to that described above (e.g., as in system 200 of FIGS. 7A-7E or as otherwise described herein). For example, image 300a is an axial image showing a fluid seal 306, a mounting flange 308 (having a radial thickness 308-1), a plastic web 310, and/or a shoulder 310-1 of a BFS product 302. In some embodiments, the image 300a can be taken by an axially-oriented camera directed toward the neck tip or end of the BFS product 302 and/or vial thereof, for example, as described above.

According to some embodiments, an image processing system (e.g., as part of an inspection system controller) can analyze the portions of the first image 300a to identify, classify, and/or analyze the imaged features 306, 308, 310, 310-1. In some embodiments, the shapes, sizes, and/or relative positions of the imaged features 306, 308, 310, 310-1 may be compared to stored shape files, geometries, thresholds, and/or parameters to determine whether the BFS product 302 in the first image 300a meets the prestored inspection criteria. In some embodiments, one or more dimensions may be derived from the first image 300a and compared to acceptable ranges and/or thresholds for the dimension to determine if the BFS product 302 passes or fails the particular test. As shown in FIG. 3A, for example, the radial thickness 308-1 of the mounting flange 308 may be analyzed to ensure that an adequate thickness is present to permit the mounting flange 308 to properly engage with a modular needle hub (not shown).

In some embodiments, image 300b may comprise a side-view image of the BFS product 302 showing the plastic webbing 310, shoulder 310-1, fluid reservoirs 312-1, 312-2, 312-3, 312-4, 312-5, collapsible reservoirs 314-1, 314-2, 314-3, 314-4, 314-5, and/or tabs 316-1, 316-2, 316-3, 316-4, 316-5. According to some embodiments, an image processing system (e.g., as part of an inspection system controller) may analyze the portions of the second image 300b to identify, classify, and/or analyze the imaged features 310, 310-1, 312-1, 312-2, 312-3, 312-4, 312-5, 314-1, 314-2, 314-3, 314-4, 314-5, 316-1, 316-2, 316-3, 316-4, 316-5. In some embodiments, the shapes, sizes, and/or relative positions of the imaged features 310, 310-1, 312-1, 312-2, 312-3, 312-4, 312-5, 314-1, 314-2, 314-3, 314-4, 314-5, 316-1, 316-2, 316-3, 316-4, 316-5 may be compared to stored shape files, geometries, thresholds, and/or parameters to determine whether the BFS product 302 in the second image 300b meets the prestored inspection criteria. In some embodiments, one or more dimensions may be derived from the second image 300b and compared to acceptable ranges and/or thresholds for the dimension to determine if the BFS product 302 passes or fails the particular test.

According to some embodiments, the presence of fluid (not separately labeled) within the BFS product 302 may be determined by location and/or identification of a fluid meniscus 318-1, 318-2, 318-3, 318-4, 318-5. The presence, shape, and/or location of each fluid meniscus 318-1, 318-2, 318-3, 318-4, 318-5 may be identified, for example, to determine or infer whether the BFS product 302 has been properly filled, stored, transported, etc. As depicted, the second image 300b may also show an area obscured by a second or upper planar drive mechanism 378.

### VI. Computer Implementation

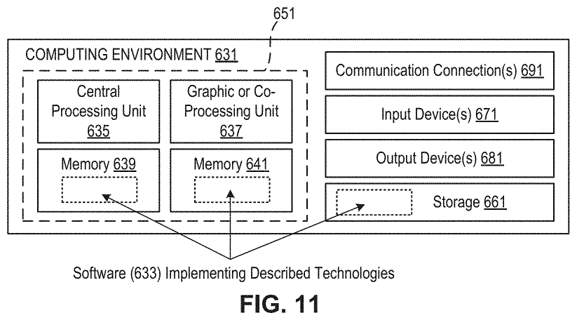

FIG. 11 depicts a generalized example of a suitable computing environment 631 in which the described innovations may be implemented, such as aspects of controller 330, controller 354, controller 374, method 400, method 600, image processing system, and/or control portion 230. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 11, the computing environment 631 includes one or more processing units 635, 637 and memory 639, 641. In FIG. 11, this basic configuration 651 is included within a dashed line. The processing units 635, 637 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 11 shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for other software executing in the computing environment 631, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 671 may be a display, printer, speaker, CD-writer, or another device that provides output from computing environment 631. The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### VII. Additional Examples of the Disclosed Technology

In view of the above described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. An inspection system for a pre-filled blow-fill-seal (BFS) product, the BFS product having first and second ends spaced from each other along a longitudinal direction, the BFS product comprising one or more necks at the first end that extend along the longitudinal direction, each neck comprising a coupling portion that protrudes laterally outward with respect to adjacent portions of the neck, the inspection system comprising:
(i) one or more first inspection stations, each first inspection station comprising:
   (a) an illumination assembly comprising one or more light sources, the illumination assembly being constructed such that interrogating light from the light sources is directed at a perimeter of, or substantially adjacent to, a coupling portion of a neck disposed at a target position; and
   (b) a detection assembly comprising one or more imaging devices, the detection assembly having an input optical axis extending from the target position along the longitudinal direction and being arranged to detect light emitted from the neck disposed at the target position; and
(ii) a controller operatively coupled to the one or more first inspection stations and configured to determine compliance of the BFS product with respect to one or more predetermined criteria based at least in part on the light detected by the one or more imaging devices.

Clause 2. The inspection system of any clause or example herein, in particular, clause 1, wherein the one or more predetermined criteria comprises an acceptable value or range of values for lateral dimension of the coupling portion, lateral dimension of one of the adjacent portions of the neck, amount of lateral protrusion of the coupling portion with respect to one of the adjacent portions of the neck, difference between lateral dimension of the coupling portion and lateral dimension of one of the adjacent portions of the neck, or any combination of the foregoing.

Clause 3. The inspection system of any clause or example herein, in particular, any one of clauses 1-2, wherein the interrogating light is directed along a plane substantially perpendicular to the longitudinal direction.

Clause 4. The inspection system of any clause or example herein, in particular, any one of clauses 1-3, wherein the interrogating light is directed substantially along a radial direction of the neck.

Clause 5. The inspection system of any clause or example herein, in particular, any one of clauses 1-4, wherein the interrogating light is directed along a first plane, and the input optical axis of the detection assembly is substantially perpendicular to the first plane.

Clause 6. The inspection system of any clause or example herein, in particular, any one of clauses 1-2, wherein an angle between the interrogating light incident on the coupling portion and the input optical axis of the detection assembly in a plane parallel to the longitudinal direction is less than 135°.

Clause 7. The inspection system of any clause or example herein, in particular, any one of clauses 1-6, wherein an angle between the interrogating light and the input optical axis is about 90°.

Clause 8. The inspection system of any clause or example herein, in particular, any one of clauses 1-7, wherein the interrogating light comprises one or more wavelengths in a range from 10 nm to 1 mm, inclusive.

Clause 9. The inspection system of any clause or example herein, in particular, any one of clauses 1-8, wherein the interrogating light comprises one or more wavelengths in a range from 400 to 700 nm, inclusive.

Clause 10. The inspection system of any clause or example herein, in particular, any one of clauses 1-9, wherein the illumination assembly comprises a light tube, an optical fiber, a lens, a filter, a reflector, or any combination thereof.

Clause 11. The inspection system of any clause or example herein, in particular, any one of clauses 1-10, wherein the detection assembly comprises a two-dimensional photodetector array.

Clause 12. The inspection system of any clause or example herein, in particular, any one of clauses 1-11, wherein the detection assembly or the controller is configured to form an image of the neck disposed at the target position based on the light detected by the one or more imaging devices.

Clause 13. The inspection system of any clause or example herein, in particular, any one of clauses 1-12, further comprising:
a transport system comprising a first drive mechanism constructed to support the BFS product at the target position and to move the BFS product to and from the first inspection station.

Clause 14. The inspection system of any clause or example herein, in particular, clause 13, wherein the first drive mechanism comprises a planar drive mechanism with a pair of rotating, opposing belts that contact the BFS product on opposite lateral sides.

Clause 15. The inspection system of any clause or example herein, in particular, clause 14, wherein the BFS product comprises a first reservoir and a second reservoir separated from the first reservoir along the longitudinal direction by a constricted portion, and the opposing belts are arranged to contact and support the BFS product at the constricted portion.

Clause 16. The inspection system of any clause or example herein, in particular, any one of clauses 14-15, wherein one or both of the belts of the planar drive mechanism has a substantially-circular shape in cross-section.

Clause 17. The inspection system of any clause or example herein, in particular, clause 14, wherein the BFS product comprises a reservoir, and the opposing belts are arranged to contact and support the BFS product at the reservoir.

Clause 18. The inspection system of any clause or example herein, in particular, any one of clauses 14 and 17, wherein one or both of the belts of the planar drive mechanism has a T-shape in cross-section.

Clause 19. The inspection system of any clause or example herein, in particular, any one of clauses 1-18, further comprising:
one or more second inspection stations, each second inspection station being configured to inspect at least a tab portion of the BFS product at the second end,
wherein the controller is operatively coupled to the one or more second inspection stations and further configured to determine compliance of the BFS product with respect to the one or more predetermined criteria based at least in part on one or more signals indicative of the inspection by the one or more second inspection stations.

Clause 20. The inspection system of any clause or example herein, in particular, clause 19, wherein one or more of the second inspection stations comprises a photodetector, a thermal imaging device, an electromagnetic wave interrogation device, a laser scanning device, a magnetic field detector, a magnetic field interrogator, or any combination thereof.

Clause 21. The inspection system of any clause or example herein, in particular, any one of clauses 19-20, wherein one or more of the second inspection stations comprises a second imaging device and a second illumination source disposed on opposite lateral sides of the BFS product or on a same side of the BFS product.

Clause 22. The inspection system of any clause or example herein, in particular, any one of clauses 19-21, further comprising:
a transport system comprising a drive mechanism constructed to support the BFS product and to move the BFS product between and within the first and second inspection stations.

Clause 23. The inspection system of any clause or example herein, in particular, clause 22, wherein:
the drive mechanism comprises a planar drive mechanism with a pair of rotating, opposing belts that contact the BFS product on opposite lateral sides, one or both of the belts of the planar drive mechanism having a substantially-circular shape in cross-section;
the BFS product comprises a first reservoir and a second reservoir separated from the first reservoir along the longitudinal direction by a constricted portion; and
the opposing belts are arranged to contact and support the BFS product at the constricted portion.

Clause 24. The inspection system of any clause or example herein, in particular, any one of clauses 19-21, further comprising:
a transport system comprising:
   (a) a first drive mechanism constructed to support and move the BFS product within the first inspection station; and
   (b) a second drive mechanism constructed to support and move the BFS product within the second inspection station; and
wherein the first and second drive mechanisms at least partially overlap to define a handoff region that conveys the BFS product between the first and second drive mechanisms.

Clause 25. The inspection system of any clause or example herein, in particular, clause 24, wherein:
the first drive mechanism comprises a planar drive mechanism with a pair of rotating, opposing first belts that contact the BFS product on opposite lateral sides of a reservoir of the BFS product, one or both of the first belts having a T-shape in cross-section; and
the second drive mechanism comprises another planar drive mechanism with a pair of rotating, opposing second belts that contact the BFS product at a narrowed portion between the second end and the reservoir of the BFS product, one or both of the second belts having a substantially-circular shape in cross-section.

Clause 26. The inspection system of any clause or example herein, in particular, any one of clauses 19-25, further comprising:
an output drive mechanism constructed to move the BFS product along different output paths,
wherein the controller is operatively coupled to the output drive mechanism and configured to:
   in response to a determination of compliance, control the output drive mechanism to move the BFS product along a first output path; and
   in response to a determination of non-compliance, control the output drive mechanism to move the BFS product along a second output path.

Clause 27. The inspection system of any clause or example herein, in particular, any one of clauses 1-26, further comprising:
one or more third inspection stations, each third inspection station being configured to inspect at least a body portion of the BFS product between the first and second ends,
wherein the controller is operatively coupled to the one or more third inspection stations and further configured to determine compliance of the BFS product with respect to the one or more predetermined criteria based at least in part on one or more signals indicative of the inspection by the one or more third inspection stations.

Clause 28. The inspection system of any clause or example herein, in particular, clause 27, wherein one or more of the third inspection stations comprises a third imaging device and a third illumination source disposed on opposite lateral sides of the BFS product.

Clause 29. The inspection system of any clause or example herein, in particular, any one of clauses 27-28, further comprising:
a transport system comprising a drive mechanism constructed to support the BFS product and to move the BFS product between and within the first and third inspection stations.

Clause 30. The inspection system of any clause or example herein, in particular, clause 29, wherein:
the drive mechanism comprises a planar drive mechanism with a pair of rotating, opposing belts that contact the BFS product on opposite lateral sides, one or both of the belts of the planar drive mechanism having a substantially-circular shape in cross-section;
the BFS product comprises a first reservoir and a tab at the second end; and
the opposing belts are arranged to contact and support the BFS product at a narrowed portion between the first reservoir and the tab.

Clause 31. The inspection system of any clause or example herein, in particular, any one of clauses 27-28, further comprising:
a transport system comprising:
   (a) a first drive mechanism constructed to support and move the BFS product within the first inspection station; and
   (b) a third drive mechanism constructed to support and move the BFS product within the third inspection station; and
wherein the first and third drive mechanisms at least partially overlap to define a handoff region that conveys the BFS product between the first and third drive mechanisms.

Clause 32. The inspection system of any clause or example herein, in particular, clause 31, wherein:
the first drive mechanism comprises a planar drive mechanism with a pair of rotating, opposing first belts that contact the BFS product on opposite lateral sides of a reservoir of the BFS product, one or both of the first belts having a T-shape in cross-section; and
the third drive mechanism comprises another planar drive mechanism with a pair of rotating, opposing third belts that contact the BFS product at a narrowed portion between a tab at the second end and the reservoir of the BFS product, one or both of the third belts having a substantially-circular shape in cross-section.

Clause 33. The inspection system of any clause or example herein, in particular, any one of clauses 27-32, further comprising:
an output drive mechanism constructed to move the BFS product along different output paths,
wherein the controller is operatively coupled to the output drive mechanism and configured to:
   in response to a determination of compliance, control the output drive mechanism to move the BFS product along a first output path; and
   in response to a determination of non-compliance, control the output drive mechanism to move the BFS product along a second output path.

Clause 34. The inspection system of any clause or example herein, in particular, any one of clauses 1-33, wherein:
the BFS product comprises a plurality of BFS vials, each BFS vial having one of the necks; and
the controller is configured to determine compliance of the entire BFS product based on inspection of only one or some of the plurality of BFS vials.

Clause 35. The inspection system of any clause or example herein, in particular, any one of clauses 1-33, wherein:
the BFS product comprises a plurality of BFS vials, each BFS vial having one of the necks; and
the controller is configured to determine compliance of the entire BFS product based on inspection of each of the plurality of BFS vials.

Clause 36. The inspection system of any clause or example herein, in particular, any one of clauses 1-35, wherein each first inspection station is constructed to inspect the neck of the BFS product as the BFS product moves laterally through the target position.

Clause 37. The inspection system of any clause or example herein, in particular, any one of clauses 1-36, wherein the inspection system is constructed to serially inspect multiple BFS products, and the controller is configured to control movement of the BFS products through the inspection system so as to define or maintain a predetermined spacing between BFS products.

Clause 38. The inspection system of any clause or example herein, in particular, any one of clauses 1-37, wherein the inspection system is constructed to serially inspect multiple BFS products, and the controller controls each first inspection station to inspect only one or some of the BFS products in a series.

Clause 39. The inspection system of any clause or example herein, in particular, any one of clauses 1-37, wherein the inspection system is constructed to serially inspect multiple BFS products, and the controller controls each first inspection station to inspect each of the BFS products in a series.

Clause 40. The inspection system of any clause or example herein, in particular, any one of clauses 1-39, wherein each first inspection station is constructed such that the BFS product is supported with at least the neck exposed at the target position.

Clause 41. The inspection system of any clause or example herein, in particular, any one of clauses 1-40, wherein each first inspection station is constructed such that the longitudinal direction is substantially parallel to gravity, and the first end is oriented downward.

Clause 42. A pre-filled blow-fill-seal (BFS) product inspection system, comprising:
a BFS product transport mechanism comprising a planar drive mechanism configured to hold a BFS product in a vertical orientation and transport the BFS product along an inspection line;
at least one lighting element configured to cast light upon a circumference of a neck of the BFS product at a positive angle with respect to an axis of the BFS product;
a vertically oriented imaging device positioned to capture an image of the neck of the BFS product along the axis of the BFS product; and
a processing device programmed to evaluate the image of the neck of the BFS product with respect to one or more stored rules and determine, based on results thereof, whether the BFS product passes inspection.

Clause 43. A method for inspecting a pre-filled blow-fill-seal (BFS) product, the BFS product having first and second ends spaced from each other along a longitudinal direction, the BFS product comprising one or more necks at the first end that extend along the longitudinal direction, each neck comprising a coupling portion that protrudes laterally outward with respect to adjacent portions of the neck, the method comprising:
(a) directing interrogating light at a perimeter of, or substantially adjacent to, a coupling portion of a neck disposed at a target position of a first inspection station;
(b) detecting, by a detection assembly having an input optical axis extending from the target position along the longitudinal direction, light emitted from the neck disposed at the target position; and
(c) determining compliance of the BFS product with respect to one or more predetermined criteria based at least in part on the detected light.

Clause 44. The method of any clause or example herein, in particular, clause 43, wherein the one or more predetermined criteria comprises an acceptable value or range of values for lateral dimension of the coupling portion, lateral dimension of one of the adjacent portions of the neck, amount of lateral protrusion of the coupling portion with respect to one of the adjacent portions of the neck, difference between lateral dimension of the coupling portion and lateral dimension of one of the adjacent portions of the neck, or any combination of the foregoing.

Clause 45. The method of any clause or example herein, in particular, any one of clauses 43-44, wherein:
(i) the interrogating light is directed along a plane substantially perpendicular to the longitudinal direction;
(ii) the interrogating light is directed substantially along a radial direction of the neck;
(iii) the interrogating light is directed along a first plane, and the input optical axis of the detection assembly is substantially perpendicular to the first plane;
(iv) an angle between the interrogating light incident on the coupling portion and the input optical axis of the detection assembly in a plane parallel to the longitudinal direction is less than 135°.
(v) an angle between the interrogating light and the input optical axis is about 900; or any combination of (i)-(v).

Clause 46. The method of any clause or example herein, in particular, any one of clauses 43-45, wherein the interrogating light comprises one or more wavelengths in a range from 10 nm to 1 mm, inclusive, and/or the interrogating light comprises one or more wavelengths in a range from 400 to 700 nm, inclusive.

Clause 47. The method of any clause or example herein, in particular, any one of clauses 43-46, wherein the directing of (a) comprises using a light tube, an optical fiber, a lens, a filter, a reflector, or any combination thereof to direct and/or focus light from one or more light sources, and/or the detecting of (b) comprises using a two-dimensional photodetector array.

Clause 48. The method of any clause or example herein, in particular, any one of clauses 43-47, wherein the detecting of (b) comprises forming an axial image of the neck disposed at the target position.

Clause 49. The method of any clause or example herein, in particular, any one of clauses 43-48, further comprising, using a first drive mechanism to (i) move the BFS product to the first inspection station, (ii) support the BFS product at the target position, and/or (iii) move the BFS product from the first inspection station.

Clause 50. The method of any clause or example herein, in particular, clause 49, wherein the first drive mechanism comprises a planar drive mechanism with a pair of rotating, opposing belts that contact the BFS product on opposite lateral sides.

Clause 51. The method of any clause or example herein, in particular, clause 50, wherein the BFS product comprises a first reservoir and a second reservoir separated from the first reservoir along the longitudinal direction by a constricted portion, and the opposing belts contact and support the BFS product at the constricted portion.

Clause 52. The method of any clause or example herein, in particular, any one of clauses 50-51, wherein one or both of the belts of the planar drive mechanism has a substantially-circular shape in cross-section.

Clause 53. The method of any clause or example herein, in particular, clause 50, wherein the BFS product comprises a reservoir, and the opposing belts contact and support the BFS product at the reservoir.

Clause 54. The method of any clause or example herein, in particular, clause 53, wherein one or both of the belts of the planar drive mechanism has a T-shape in cross-section.

Clause 55. The method of any clause or example herein, in particular, any one of clauses 43-54, further comprising (d) inspecting a tab portion of the BFS product at the second end, wherein the determining compliance of (c) is further based, at least in part, on the inspection of the tab portion.

Clause 56. The method of any clause or example herein, in particular, clause 55, wherein the inspecting of (d) comprises using a photodetector, a thermal imaging device, an electromagnetic wave interrogation device, a laser scanning device, a magnetic field detector, a magnetic field interrogator, or any combination thereof.

Clause 57. The method of any clause or example herein, in particular, any one of clauses 55-56, wherein the inspecting of (d) comprises using an imaging device and an illumination source disposed on opposite lateral sides of the BFS product or on a same side of the BFS product.

Clause 58. The method of any clause or example herein, in particular, any one of clauses 55-57, wherein the inspecting of (d) is performed at a second inspection station, and the method further comprises using a transport system to (i) move the BFS product between the first and second inspection stations, (ii) support the BFS product within the first inspection station, and/or (iii) support the BFS product within the second inspection station.

Clause 59. The method of any clause or example herein, in particular, clause 58, wherein the transport system comprises a planar drive mechanism with a pair of rotating, opposing belts that contact the BFS product on opposite lateral sides, one or both of the belts of the planar drive mechanism having a substantially-circular shape in cross-section, the BFS product comprises a first reservoir and a second reservoir separated from the first reservoir along the longitudinal direction by a constricted portion, and the opposing belts contact and support the BFS product at the constricted portion.

Clause 60. The method of any clause or example herein, in particular, any one of clauses 55-57, wherein the inspecting of (d) is performed at a second inspection station, and the method further comprises (e1) using a first drive mechanism to support and move the BFS product within the first inspection station; (e2) using a second drive mechanism to support and move the BFS product within the second inspection station; and (e3) transfer the BFS product between the first and second drive mechanisms in an overlapping handoff region.

Clause 61. The method of any clause or example herein, in particular, clause 60, wherein the first drive mechanism comprises a planar drive mechanism with a pair of rotating, opposing first belts that contact the BFS product on opposite lateral sides of a reservoir of the BFS product, one or both of the first belts having a T-shape in cross-section, and the second drive mechanism comprises another planar drive mechanism with a pair of rotating, opposing second belts that contact the BFS product at a narrowed portion between the second end and the reservoir of the BFS product, one or both of the second belts having a substantially-circular shape in cross-section.

Clause 62. The method of any clause or example herein, in particular, any one of clauses 45-61, further comprising (g) inspecting a body portion of the BFS product, wherein the determining compliance of (c) is further based, at least in part, on the inspection of the body portion.

Clause 63. The method of any clause or example herein, in particular, clause 62, wherein the inspecting of (g) comprises using an imaging device and an illumination source disposed on opposite lateral sides of the BFS product.

Clause 64. The method of any clause or example herein, in particular, any one of clauses 62-63, wherein the inspecting of (g) is performed at a third inspection station, and the method further comprises using a transport system to (i) move the BFS product between the first and third inspection stations, (ii) support the BFS product within the first inspection station, and/or (iii) support the BFS product within the third inspection station.

Clause 65. The method of any clause or example herein, in particular, clause 64, wherein the transport system comprises a planar drive mechanism with a pair of rotating, opposing belts that contact the BFS product on opposite lateral sides, one or both of the belts of the planar drive mechanism having a substantially-circular shape in cross-section, the BFS product comprises a first reservoir and a tab at the second end, and the opposing belts contact and support the BFS product at a narrowed portion between the first reservoir and the tab.

Clause 66. The method of any clause or example herein, in particular, any one of clauses 62-63, wherein the inspecting of (g) is performed at a third inspection station, and the method further comprises (h1) using a first drive mechanism to support and move the BFS product within the first inspection station; (h2) using a second drive mechanism to support and move the BFS product within the third inspection station; and (h3) transfer the BFS product between the first and second drive mechanisms in an overlapping handoff region.

Clause 67. The method of any clause or example herein, in particular, clause 66, wherein the first drive mechanism comprises a planar drive mechanism with a pair of rotating, opposing first belts that contact the BFS product on opposite lateral sides of a reservoir of the BFS product, one or both of the first belts having a T-shape in cross-section, and the third drive mechanism comprises another planar drive mechanism with a pair of rotating, opposing third belts that contact the BFS product at a narrowed portion between a tab at the second end and the reservoir of the BFS product, one or both of the third belts having a substantially-circular shape in cross-section.

Clause 68. The method of any clause or example herein, in particular, any one of clauses 43-67, wherein the BFS product comprises a plurality of BFS vials, each BFS vial having a respective neck, the directing of (a) and detecting of (b) is for only one or some of the plurality of BFS vials, and the determining compliance of (c) is for the entire BFS product.

Clause 69. The method of any clause or example herein, in particular, any one of clauses 43-68, wherein the BFS product comprises a plurality of BFS vials, each BFS vial having a respective neck, the directing of (a) and detecting of (b) is for all of the plurality of BFS vials, and the determining compliance of (c) is for the entire BFS product.

Clause 70. The method of any clause or example herein, in particular, any one of clauses 43-68, wherein the directing of (a) and detecting of (b) are performed as the BFS product moves laterally through the target position.

Clause 71. The method of any clause or example herein, in particular, any one of clauses 43-70, further comprising serially repeating (a)-(c) for each BFS product in a train of separate BFS products.

Clause 72. The method of any clause or example herein, in particular, any one of clauses 43-70, further comprising serially repeating (a)-(c) for only one or some BFS products in a train of separate BFS products.

Clause 73. The method of any clause or example herein, in particular, any one of clauses 71-72, further comprising controlling movement of the BFS products so as to define or maintain a predetermined spacing between the BFS products in the train.

Clause 74. The method of any clause or example herein, in particular, any one of clauses 43-73, further comprising, during (a) and (b), supporting the BFS product with at least the neck exposed at the target position.

Clause 75. The method of any clause or example herein, in particular, any one of clauses 43-74, wherein during (a) and (b), the longitudinal direction is substantially parallel to gravity, and the first end is oriented downward.

Clause 76. The method of any clause or example herein, in particular, any one of clauses 43-75, further comprising (f1) selecting an output path for the BFS product from a plurality of output paths based at least in part on the determining of (c); and (f2) moving the BFS product along the selected output path.

Clause 77. A controller for an inspection system, the controller comprising one or more processors and computer readable storage media storing instructions that, when executed by the one or more processors, cause the inspection system to perform the method of any clause or example herein, in particular, any one of clauses 43-76.

### VIII. Rules of Interpretation

Any or all of the components disclosed herein can be formed of one or more plastics. In some embodiments, some components (e.g., the BFS vials) can be formed of a relatively soft polymer (e.g., having a Shore/Durometer “D” hardness of between 60 and 70), such as polyethylene (e.g., low density polyethylene (LDPE)), polypropylene, or any other polymer adaptable for use in a BFS manufacturing process. In some embodiments, some components (e.g., the connection assemblies, the administration assemblies, and/or needle caps or covers) can be formed, at least in part, of a relatively hard polymer (e.g., having a hardness greater than 80 on the Rockwell “R” scale), such as, but not limited to, polypropylene, polycarbonate, polybenzimidazole, acrylonitrile butadiene styrene (ABS), polystyrene, polyvinyl chloride, or the like. Other materials are also possible according to one or more contemplated embodiments.

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s).

While the term “modules” is utilized herein for convenience and ease of illustration, objects represented and/or described as “modules” may comprise various forms, configurations, and/or quantities of components. A BFS module may comprise one or more BFS products that are formed and/or manufactured together or separately, for example, and/or may comprise one or more BFS chambers, bottles, containers, and/or other fluid-retaining objects. The term “module” does not convey any designation of shape or size. In some embodiments, a BFS module may comprise one or more vials. According to some embodiments a BFS module and/or a BFS vial may comprise one or more fluid chambers. In some embodiments, a plurality of BFS modules, components, vials, and/or chambers may be manufactured simultaneously from a single BFS mold. Each respective module and/or chamber may be formed, for example, by different portions of a single BFS mold (e.g., two cooperative halves thereof). In some embodiments, BFS modules, components, vials, and/or chambers may be joined and/or coupled during manufacturing (e.g., via unformed and/or fused connecting parison) and/or after manufacturing/filling.

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like

The terms “including”, “comprising” and variations thereof mean “including but not limited to”, unless expressly specified otherwise. As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including ten percent (10%) of that value are intended, unless explicitly stated otherwise.

Directions and other relative references may be used to facilitate discussion of the drawings and principles herein, but are not intended to be limiting. For example, certain terms may be used such as “inner,” “outer,”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### IX. Conclusion

Any of the features illustrated or described with respect to FIGS. 1A-11 and Clauses 1-77 can be combined with any other features illustrated or described with respect to FIGS. 1A-11 and Clauses 1-77 to provide systems, machines, assemblies, modules, products, methods, and embodiments not otherwise illustrated or specifically described herein. For example, the outfeed drive configuration employed in the rejection processing section of FIGS. 8I-8J can be used in place of the outfeed drive configuration employed in rejection processing section of FIG. 9H, and vice versa. Other combinations and variations are also possible according to one or more contemplated embodiments. All features described herein are independent of one another and, except where structurally impossible, can be used in combination with any other feature described herein.

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. An inspection system for a pre-filled blow-fill-seal (BFS) product, the BFS product having first and second ends spaced from each other along a longitudinal direction, the BFS product comprising one or more necks at the first end that extend along the longitudinal direction, each neck comprising a coupling portion that protrudes laterally outward with respect to adjacent portions of the neck, the inspection system comprising:
(i) one or more first inspection stations, each first inspection station comprising:
(a) an illumination assembly comprising one or more light sources, the illumination assembly being constructed such that interrogating light from the light sources is directed at a perimeter of a coupling portion of a neck disposed at a target position; and
(b) a detection assembly comprising one or more imaging devices, the detection assembly having an input optical axis extending from the target position along the longitudinal direction and being arranged to detect light emitted from the neck disposed at the target position; and
(ii) a controller operatively coupled to the one or more first inspection stations and configured to determine compliance of the BFS product with respect to one or more predetermined criteria based at least in part on the light detected by the one or more imaging devices.

2. The inspection system of claim 1, wherein the one or more predetermined criteria comprises an acceptable value or range of values for lateral dimension of the coupling portion, lateral dimension of one of the adjacent portions of the neck, amount of lateral protrusion of the coupling portion with respect to one of the adjacent portions of the neck, difference between lateral dimension of the coupling portion and lateral dimension of one of the adjacent portions of the neck, or any combination of the foregoing.

3. The inspection system of claim 1, wherein the interrogating light is directed along a plane substantially perpendicular to the longitudinal direction.

4. The inspection system of claim 1, wherein the interrogating light is directed substantially along a radial direction of the neck.

5. The inspection system of claim 1, wherein the interrogating light is directed along a first plane, and the input optical axis of the detection assembly is substantially perpendicular to the first plane.

6. The inspection system of claim 1, wherein an angle between the interrogating light incident on the coupling portion and the input optical axis of the detection assembly in a plane parallel to the longitudinal direction is less than 135°.

7. The inspection system of claim 1, wherein an angle between the interrogating light and the input optical axis is about 90°.

8. The inspection system of claim 1, wherein the interrogating light comprises one or more wavelengths in a range from 10 nm to 1 mm, inclusive.

9. The inspection system of claim 8, wherein the interrogating light comprises one or more wavelengths in a range from 400 to 700 nm, inclusive.

10. The inspection system of claim 1, wherein the illumination assembly comprises a light tube, an optical fiber, a lens, a filter, a reflector, or any combination thereof.

11. The inspection system of claim 1, wherein the detection assembly comprises a two-dimensional photodetector array.

12. The inspection system of claim 1, wherein the detection assembly or the controller is configured to form an image of the neck disposed at the target position based on the light detected by the one or more imaging devices.

13. The inspection system of claim 1, further comprising:
a transport system comprising a first drive mechanism constructed to support the BFS product at the target position and to move the BFS product to and from the first inspection station.

14. The inspection system of claim 13, wherein the first drive mechanism comprises a planar drive mechanism with a pair of rotating, opposing belts that contact the BFS product on opposite lateral sides.

15. The inspection system of claim 14, wherein the BFS product comprises a first reservoir and a second reservoir separated from the first reservoir along the longitudinal direction by a constricted portion, and the opposing belts are arranged to contact and support the BFS product at the constricted portion.

16. The inspection system of claim 14, wherein one or both of the belts of the planar drive mechanism has a substantially-circular shape in cross-section.

17. The inspection system of claim 14, wherein the BFS product comprises a reservoir, and the opposing belts are arranged to contact and support the BFS product at the reservoir.

18. The inspection system of claim 17, wherein one or both of the belts of the planar drive mechanism has a T-shape in cross-section.

19. The inspection system of claim 1, further comprising:
one or more second inspection stations, each second inspection station being configured to inspect at least a tab portion of the BFS product at the second end,
wherein the controller is operatively coupled to the one or more second inspection stations and further configured to determine compliance of the BFS product with respect to the one or more predetermined criteria based at least in part on one or more signals indicative of the inspection by the one or more second inspection stations.

20. The inspection system of claim 19, wherein one or more of the second inspection stations comprises a photodetector, a thermal imaging device, an electromagnetic wave interrogation device, a laser scanning device, a magnetic field detector, a magnetic field interrogator, or any combination thereof.

21. The inspection system of claim 19, wherein one or more of the second inspection stations comprises a second imaging device and a second illumination source disposed on opposite lateral sides of the BFS product or on a same side of the BFS product.

22. The inspection system of claim 19, further comprising:
a transport system comprising a drive mechanism constructed to support the BFS product and to move the BFS product between and within the first and second inspection stations.

23. The inspection system of claim 22, wherein:
the drive mechanism comprises a planar drive mechanism with a pair of rotating, opposing belts that contact the BFS product on opposite lateral sides, one or both of the belts of the planar drive mechanism having a substantially-circular shape in cross-section;
the BFS product comprises a first reservoir and a second reservoir separated from the first reservoir along the longitudinal direction by a constricted portion; and
the opposing belts are arranged to contact and support the BFS product at the constricted portion.

24. The inspection system of claim 19, further comprising:
a transport system comprising:
(a) a first drive mechanism constructed to support and move the BFS product within the first inspection station; and
(b) a second drive mechanism constructed to support and move the BFS product within the second inspection station; and
wherein the first and second drive mechanisms at least partially overlap to define a handoff region that conveys the BFS product between the first and second drive mechanisms.

25. The inspection system of claim 24, wherein:
the first drive mechanism comprises a planar drive mechanism with a pair of rotating, opposing first belts that contact the BFS product on opposite lateral sides of a reservoir of the BFS product, one or both of the first belts having a T-shape in cross-section; and
the second drive mechanism comprises another planar drive mechanism with a pair of rotating, opposing second belts that contact the BFS product at a narrowed portion between the second end and the reservoir of the BFS product, one or both of the second belts having a substantially-circular shape in cross-section.

26. The inspection system of claim 19, further comprising:
an output drive mechanism constructed to move the BFS product along different output paths,
wherein the controller is operatively coupled to the output drive mechanism and configured to:
in response to a determination of compliance, control the output drive mechanism to move the BFS product along a first output path; and
in response to a determination of non-compliance, control the output drive mechanism to move the BFS product along a second output path.

27. The inspection system of claim 1, further comprising:
one or more third inspection stations, each third inspection station being configured to inspect at least a body portion of the BFS product between the first and second ends,
wherein the controller is operatively coupled to the one or more third inspection stations and further configured to determine compliance of the BFS product with respect to the one or more predetermined criteria based at least in part on one or more signals indicative of the inspection by the one or more third inspection stations.

28. The inspection system of claim 27, wherein one or more of the third inspection stations comprises a third imaging device and a third illumination source disposed on opposite lateral sides of the BFS product.

29. The inspection system of claim 27, further comprising:
a transport system comprising a drive mechanism constructed to support the BFS product and to move the BFS product between and within the first and third inspection stations.

30. The inspection system of claim 29, wherein:
the drive mechanism comprises a planar drive mechanism with a pair of rotating, opposing belts that contact the BFS product on opposite lateral sides, one or both of the belts of the planar drive mechanism having a substantially-circular shape in cross-section;
the BFS product comprises a first reservoir and a tab at the second end; and
the opposing belts are arranged to contact and support the BFS product at a narrowed portion between the first reservoir and the tab.

31. The inspection system of claim 27, further comprising:
a transport system comprising:
(a) a first drive mechanism constructed to support and move the BFS product within the first inspection station; and
(b) a third drive mechanism constructed to support and move the BFS product within the third inspection station; and
wherein the first and third drive mechanisms at least partially overlap to define a handoff region that conveys the BFS product between the first and third drive mechanisms.

32. The inspection system of claim 31, wherein:
the first drive mechanism comprises a planar drive mechanism with a pair of rotating, opposing first belts that contact the BFS product on opposite lateral sides of a reservoir of the BFS product, one or both of the first belts having a T-shape in cross-section; and
the third drive mechanism comprises another planar drive mechanism with a pair of rotating, opposing third belts that contact the BFS product at a narrowed portion between a tab at the second end and the reservoir of the BFS product, one or both of the third belts having a substantially-circular shape in cross-section.

33. The inspection system of claim 27, further comprising:
an output drive mechanism constructed to move the BFS product along different output paths,
wherein the controller is operatively coupled to the output drive mechanism and configured to:
in response to a determination of compliance, control the output drive mechanism to move the BFS product along a first output path; and
in response to a determination of non-compliance, control the output drive mechanism to move the BFS product along a second output path.

34. The inspection system of claim 1, wherein:
the BFS product comprises a plurality of BFS vials, each BFS vial having one of the necks; and
the controller is configured to determine compliance of the entire BFS product based on inspection of only one or some of the plurality of BFS vials.

35. The inspection system of claim 1, wherein:
the BFS product comprises a plurality of BFS vials, each BFS vial having one of the necks; and
the controller is configured to determine compliance of the entire BFS product based on inspection of each of the plurality of BFS vials.

36. The inspection system of claim 1, wherein each first inspection station is constructed to inspect the neck of the BFS product as the BFS product moves laterally through the target position.

37. The inspection system of claim 1, wherein the inspection system is constructed to serially inspect multiple BFS products, and the controller is configured to control movement of the BFS products through the inspection system so as to define or maintain a predetermined spacing between BFS products.

38. The inspection system of claim 1, wherein the inspection system is constructed to serially inspect multiple BFS products, and the controller controls each first inspection station to inspect only one or some of the BFS products in a series.

39. The inspection system of claim 1, wherein the inspection system is constructed to serially inspect multiple BFS products, and the controller controls each first inspection station to inspect each of the BFS products in a series.

40. The inspection system of claim 1, wherein each first inspection station is constructed such that the BFS product is supported with at least the neck exposed at the target position.

41. The inspection system of claim 1, wherein each first inspection station is constructed such that the longitudinal direction is substantially parallel to gravity, and the first end is oriented downward.
